(19) United States
(12) Patent Application Publication
(10) Pub. No.: US 2016/0030913 A1
(43) Pub. Date: Feb. 4, 2016

(54) METHOD OF IRRADIATING A MAGNETIC FLUID CONTAINING A SEMICONDUCTOR PIGMENT AND METAL MICROPARTICLES WITH MICROWAVES, THEREBY CREATINGMIXED-PHASE FLUID, AND AMPLIFYING THE SUPERFLUID STATE ENERGY BY MEANS OF THE QUANTUM TURBULENCE PHENOMENON.

(71) Applicants: Buhei KONO, Kyoto-shi, Kyoto (JP); Kazuhito KONO, Kyoto-shi, Kyoto (JP)

(72) Inventors: Buhei KONO, Kyoto-shi, Kyoto (JP); Kazuhito KONO, Kyoto-shi, Kyoto (JP)

(21) Appl. No.: 14/762,696

(22) PCT Filed: Feb. 7, 2014
(86) PCT No.: PCT/JP2014/053826

§ 371 Date: Sep. 28, 2015

(30) Foreign Application Priority Data
Feb. 13, 2013 (JP) 2013-041199

(51) Int. Cl. B01J 19/12

(52) U.S. Cl. CPC B01J 19/126; B01J 2219/1206; B01J 2219/0877

(57) ABSTRACT

A method of amplifying the energy of a superfluid by irradiating a paramagnetic body, diamagnetic body, ferromagnetic and ferromagnetic metal microparticles with microwaves, thereby creating a superfluid phenomenon to generate superfluid energy, wherein a mixed phase electromagnetic fluid containing a semiconductor pigment is created and irradiated with microwaves, and when an external magnetic field is applied thereto, quantum chaos occurs, generating quantum turbulence phenomenon, thereby amplifying the energy of superfluid. Microparticles of an element, an oxide or a compound that creates a superfluid phenomenon in microwave band, are sorted from a diamagnetic or a paramagnetic material according to microwave frequency, and introduced into a mixed liquor containing a surfactant and a liquid characterized by containing an organic polyphenol. By activating the reaction of surface electrons, the mixed liquor is converted into a structure having a certain degree of magnetization. Superfluid energy is generated by ferromagnetic or ferrimagnetic microparticles, metal microparticles, and carbon material at ambient temperature and ambient pressure, quantum chaos occurs in the mixed phase electromagnetic fluid with mixed phase semiconductor pigment, and the energy of the superfluid is amplified by quantum turbulence phenomenon.

### BACKGROUND OF INVENTION

The present invention relates to a method of increasing energy of electromagnetic fluid in which magnetic fluid and metal particles transforming ferromagnetism by microwave and thus multiple phase electromagnetic fluid becomes quantum mechanical superfluid. The energy of quantum mechanical superfluid is increased by adding semiconductor pigment to aforementioned electromagnetic fluid by quantum turbulence occurring quantum chaos.

An invention of electric generator that we insert Argon gas and gold, silver, platinum, platinum rhodium of noble metal particles or rod, apply magnetic field using permanent magnet, heat them by microwave, milliwave or high frequency wave and cool by water, is disclosed as Japan patent number 4904528. This invention is based on the energy of magnetization deviation and magnetic resonance of ferrofluid interacting with plasma of Ar gas and plasmon of gold, silver, platinum, platinum rhodium of noble metal particles or rod. We can make electric generator rotating ferro-fluid with fins as disclosed Japan patent 4904528.

An invention of transforming magnetic properties of gold, silver, platinum, copper, titan, tin, carbon, silicon and aluminum of diamagnetism or paramagnetic particles for usage for new materials by the change of ionized rate and conductivity is disclosed as Japan patent application Number 2012-250639.

Ferromagnetized transformation of Cu complex in organic solvent by superexchange interaction by irradiation of light is shown in the article by Jungjoo Yoon, Liviu M. Mirica, T. Daniel P. Stack, Edward E Solomon.

“Spectroscopic Demonstration of a Large Antisymmetric Exchange Contribution to the Spin-frustrated Ground State of a D3 Symmetric Hydroxyl-Bridged Trinuclear Cu(II)Complex: Ground-to-Excited State superexchange Pathways”

Jungjoo Yoon, Liviu M. Mirica, T. Daniel P. Stack, Edward E Solomon, et al Stanford University J. AM. CHEM, SOC. 2004 page 12586˜page 12595

Microscopic quantum mechanical effect is amplified macroscopic quantum effect in many body particles by Bose-Einstein condensation which is a mechanism of superconductivity and superfluidity. This fact is explained in following book.

“Quantum Theory of many particles System”, Author Alexander L. Fetter and John Dirk Walecka, Dover edition page 413˜page 495

When we irradiate microwaves to magnetic materials in room temperature, parallel pumping occurs in Bose-Einstein condensation and macroscopic quantum mechanics as superfluidity and superconductivity. This fact is shown in Author, V. E. Demitov, O. Dzyapko, S. O. Demokritov, G. A. Melkov and A. N. Slavin in a following articles.

Observation of Spontaneous Coherent in Bose-Einstein Condensate of Magnons

Author, V. E. Demitov, O. Dzyapko, S. O. Demokritov, G. A. Melkov and A. N. Slavin

University of Muenster, Department of physics Oakland University Feb. 1, 2008 Physical Review letters

page 047205-1˜page 047205-4

When we irradiate microwaves to magnetic material in room temperature and parallel pumping is induced, soliton wave is induced. This fact is described in “Observation of the amplification of spin-wave envelop soliton in ferromagnetic films by parallel magnetic pumping, Author B. A. Kalinikos, N. G. Kovshikov, and M. P. Kostylev, St. Peteresburg Electrical Engineering University, P. Kabos and C. E. Patton, Colorado State University, 1997 American Institute of physics”

Quantum Turbulence of quantum vortices in quantum fluid by Bose-Einstein condensation in superfluidity is described in following articles.

Holographic vortex Liquids and Superfluid Turbulence

Paul M. Chesler, Hong Liu, Allan Adams

Department of physics Massachusetts Institute of Technology

26 Jul. 2013 Science Vol 341 page 368 to page 372

When both spin symmetry of ferromagnetic fluid and electromagnetic field of spin orbital symmetry are broken in the same time, superfluid phenomena are observed. This is shown in 2003 Nobel prize winners, Anthony Leggett, Alexei Abrikosov and Vitaly Ginzburg in a following reference.

Advanced information on the Nobel Prize in Physics, 7 Oct. 2003

Kungl. Vetenskapsakademien

The royal Swedish academy of sciences

Superfluids and superconductors: quantum mechanics on a macroscopic scale

Cyclic perpetual motion in superfluid phenomena in quantum symmetry breaking is shown theoretically in Wilczek in following articles.

“Quantum Time Crystals”

Frank Wilczek Center of Theoretical Physics Department of physics

Massachusetts Institute of Technology

Physical Review Letter. 109.160401

“Classical Time Crystals”

Frank Wilczek Center of Theoretical Physics Department of physics

Massachusetts Institute of Technology

Physical Review Letter. 109.160402

“Super fluidity and space-Time translation symmetry breaking”

Frank Wilczek Center of Theoretical Physics Department of physics

Massachusetts Institute of Technology

Physical Review Letter. 111.250402

We can make magnetohydrodynamics generator by liquid metal and ionized plasma. When we change the gradient of fluid route, electro-magnetic fluid becomes compressible magnetic fluid. As a result of that electromagnetic fluid becomes subsonic or supersonic wave then the energy efficiency reforms about 40% compared to same input velocity, electric field and magnetic flux density. This fact is described in “MIT core-curriculum,

Electrodynamics III Author, R. H. Woodson, J. R. Melcher

When the model of magnetic fluid of low temperature plasma propagates perpendicular to magnetic field, Alfven wave and solution wave are induced. This fact is described in Methods in Nonlinear Plasma theory

Ronald C. Davidson

University of Maryland College Park, Maryland

Academic Press

Volume 37 in pure and applied physics

A series of Monograph and Textbooks

Chapter 2. The Korteweg-de Vries Equation

A weakly Nonlinear theory of ion sound waves page 15 to page 31

When longitudinal wave occurs in compressible electromagnetic fluid, sonic wave occurs in a case that velocity of particles and direction of electromagnetic wave are parallel to magnetic field because fluid particles motions do not disturb magnetic flux line. Such sonic wave proceeds in fluid in a velocity of sound speed C₀. If speed of velocity is parallel to propagation but perpendicular to magnetic field, compressible longitudinal Alfven wave occurs by magnetic pressure and fluid pressure. This velocity of this wave is following.

(C₀+μH₀²/ρ)^{1/2}

C₀; speed of sound μ; permeability, H₀; magnetic field, ρ, density

This fact is described in” Introductory to magnetohydrodynamic/plasma

Author V. C. A. Ferraro and C. Plumpton

Thus, because magnetic field is not uniform and magnetic fluid is compressed, the energy is amplified by occurring Alfven wave of longitudinal wave.

The Nambu theory of superconductivity explains that electromagnetic wave acquires mass by collective longitudinal plasmon mode and spin Bose-Einstein condensation

This is described in Quantum Field Theory, Author Lewis Ryder, Cambridge University press.

Photoluminescence is occurred by the plasma of exciton created electron and hole recombination in semiconductor pigment in CdS and CdSe is shown in following articles.

“Dynamics and mechanism of recombination of electron-hole plasma and high density excitons in CdS and CdSe.”

V. S Dneprovskii, V. I. Klimov, and M. G. Novikov

Moscow State University

Sov. phys. JFTP 72(3) March 1991 1991 American Institute of physics

Page 468˜Page476

When we irradiate microwaves semiconductor applying magnetic field, Alfven and Helicon waves are excited. This fact is shown in following article.

“Parametric excitation of Alfven and helicon waves in magnetoactive compensated semiconductor by microwave radiation”

A. A. Mamun and M. Salimullah

Department of physics Jahangirnagar University

Physical Review B volume 44, Number 16 15 Oct. 1991

Page 8685˜8693

Amplification of quantum photo-luminescence efficiency by surface activation of semiconductor is explained in following article Lubomir Spanhel, Markus Haase, Horst Weller and Arnim Henglein.

Photochemistry of colloidal Semiconductor. 20. Surface Modification and Stability of strong Luminescing CdS particles

Lubomir Spanhel, Markus Haase, Horst Weller and Arnim Henglein

Hahn-Metiner-Institute Berlin, Federal Republic of Germany

J. Am. Chem. Soc 1987, 109, Page 5649-Page5655

Perpetual periodic motion occurs of crest type vortices by reaction and diffusion of multiple chemicals. This fact is known as Belousov and Zabotinski reaction in following article.

A. N. Zaikin and A. M. Zabotinski, Nature, 225, 535-537(1970)

Quantum soliton occurs in quantum kicked rotator in quantum chaos. Theoretical investigation of that is shown in following article but experimental proof is not done yet. Manifestations of classical and quantum chaos in nonlinear wave propagation

Francesco Benvenuto and Giulio Casati

Dipartimento di Fisica dell Universita Italy

Arkady S. Pikovsky

Institute of Applied Physics 603600 Gorky, U.S.S.R.

Dima L. Shepelyansky

Institute of Applied Physics 603600 Gorky, U.S.S.R.

Physical Review A volume 44 number 6 15 Sep. 1991

Page 3423˜Page 3426

The energy of quantum fluid is amplified in quantum turbulent state in quantum vortices by gauge field plasmon by occurring quantum chaos in semiconductor material applied magnetic field. That is shown theoretically in following article but experimental test is not done yet.

Turbulence and Spatial Correlation of Currents in Quantum Chaos

John R. Evans and Mark I. Stockman

Department of Physics and Astronomy: Georgia State University

Physical Review letters volume 81 Number 21 23 Nov. 1998

Page 4624˜Page 4627

### SUMMARY OF INVENTION

We analyze superfluid phenomena of microwaves in room temperature and room pressure and discover superfluid energy by microwaves.

Superfluid is macroscopic quantum mechanical effect by Bose-Einstein condensation. Quantum vortices by spins occur in superfluid condition. When we irradiate microwaves to magnetic materials in room temperature, Bose-Einstein condensation of macroscopic quantum mechanics such as superconductivity or superfluidity occurs. This fact is shown in reference by Author, V. E. Demitov, O. Dzyapko, S. O. Demokritov, G. A. Melkov and A. N. Slavin. When spins become Bose-Einstein condensation and longitudinal plasma waves occur, gauge field (electromagnetic field) acquires mass (energy) in superconductor Nambu theory in following articles.

“Nobel Lecture: Spontaneous symmetry breaking in particle physics: A case of cross fertilization”

Yoichiro Nambu, University of Chicago Reviews of Modern physics, volume 81, July-September 2009

This is described in Quantum Field Theory, Author Lewis Ryder, Cambridge University press.

When both spin symmetry of ferromagnetic fluid and electromagnetic field of spin orbital symmetry are broken in the same time, superfluid phenomena are observed. This is shown in 2003 Nobel prize winners, Anthony Leggett, Alexei Abrikosov and Vitaly Ginzburg in a following reference.

Advanced information on the Nobel Prize in Physics, 7 Oct. 2003

Kungl. Vetenskapsakademien

The royal Swedish academy of sciences

Ferromagnetic or ferrimagnetic powder is used in magnetic fluid. The magnetic fluid which absorbs total microwaves does not make superfluid phenomena because they do not induce collective longitudinal plasma phenomena. As a result of that, quantum vortices of Bose-Einstein condensation are not observed.

We mix metal particles which have different magnetization rate and absorption rate of electromagnetic waves and ferromagnetism or ferrimagnetism particles thus make magnetic fluid. When we irradiate microwaves to aforementioned magnetic fluid and apply magnetic field, collective plasma phenomena of longitudinal plasmon waves occur, magnetoplasmon effect by Bose-Einstein condensation is observed and thus superfluid phenomena of occurring quantum vortices are observed.

To induce magnetoplasmon effect, we use paramagnetic particles, component or oxidized particles of Titan, Vanadium, Platinum, Stannum, Tungsten, Aluminum, Zyrconia, Neodymium, Molybdenum or Paradium and Copper, Zinc, Silicon, Silver, Cadmium, Selenium, Stannum, Platinum, Stibium, Hydragyrum, Indium, Bismuth or Phosphorous. Also we use oxidized particles of Manganese, Nickel, Crome, Iron or Cobalt. We mix aforementioned particles in ferromagnetic and ferrimagnetism particles and immerse aforementioned mixed particles in red wine, cassis alcohol, grape juice and blueberry juice which include polyphenol, malic acid and citric acid with adding surface activated materials to diffuse that liquid and increase photo-enhancement sensibility. When we irradiate microwaves to aforementioned fluid liquid, paramagnetic particles, component or oxidized particles of Titan, Vanadium, Platinum, Stannum, Tungsten, Aluminum, Zyrconia, Neodymium, Molybdenum and Paradium and copper, Zinc, Silicon, Silver, Cadmium, Selenium, Stannum, Platinum, Stibium, Hydragyrum, Indium, Bismuth or Phosphorous, Oxidized compound of Mn, Ni, Cr, Fe or Co such as MnO₄, CrO₇, Fe₂O₃, CoO or NiO show magnetization. These material structure particles show spontaneous magnetization by excitation of unpaired electron of void of metal crystal lattice by magnetic resonance. Also inorganic materials Silicon, Silicon Carbide, Carbon fiber or activated carbon show spontaneous magnetization.

The example of non magnetic (Not ferromagnetic) elements and their compound show ferromagnetism is the article by Jungjoo Yoon, Liviu M. Mirica, T. Daniel P. Stack, Edward E Solomon.

Ferromagnetism transformation of Cu complex in organic solvent by superexchange interaction by irradiation of light is shown aforementioned article.

An invention of transforming magnetic properties of gold, silver, platinum, copper, titan, tin, carbon, silicon or aluminum of diamagnetism or paramagnetic particles for usage for new materials by the change of ionized rate and conductivity is disclosed as Japan patent application Number 2012-250639.

Ferromagnetism and ferrimagnetism or their compound magnetic materials is observed by unpaired electron of d electron band. We can make micron scale magnetized particles, nano size magnetized particle processing is very expensive and so micron size processing has large economical merit.

When both spin symmetry of ferromagnetic fluid and electromagnetic field of spin orbital symmetry are broken in the same time, superfluid phenomena are observed. This is shown in 2003 Nobel prize winners, Anthony Leggett, Alexei Abrikosov and Vitaly Ginzburg in a following reference.

Advanced information on the Nobel Prize in Physics, 7 Oct. 2003

Kungl. Vetenskapsakademien

The royal Swedish academy of sciences

We mix different magnetization rate and different electromagnetic waves absorption rate metal particles and ferromagnetic or ferrimagnetic particles and make magnetic fluid. When we irradiate microwaves to aforementioned magnetic fluid and apply magnetic field, superfluid phenomena of quantum vortices are observed.

When we mix carbon particles which are carbon fiber or activated carbon with magnetic fluid and apply microwaves, not-equilibrium electromagnetic field is formed in liquid of aforementioned magnetic field by electrons emission from surface of aforementioned carbon particles and form plasma surrounding the surface of aforementioned carbon particles. Thus superfluid phenomena of quantum vortices are observed in aforementioned mixed state electromagnetic fluid thus energy is amplified.

Next generation economical energy is solved by quantum mechanical energy. The superfluid phenomena are such a quantum mechanical energy.

We mix semiconductor pigment particles to Titan, Vanadium, Platinum, Stannum, Tungsten, Aluminum, Zyrconia, Neodymium, Molybdenum and Paradium and copper, Zinc, Silicon, Silver, Cadmium, Selenium, Stannum, Platinum, Stibium, Hydragyrum, Indium, Bismuth or Phosphorous, Oxidized compound of Mn, Ni, Cr, Fe or Co and increase photosensitivity and irradiate microwaves to aforementioned particles in liquid Thus we carry out the experiment for wavelength interference effect using microwaves to increase superfluid energy of aforementioned magnetic fluid which includes more than 2 kinds of different electromagnetic wave absorption rate metal particles.

An interaction of light or electromagnetic waves and CdS and CdSe semiconductor materials and its effect is described in following articles.

“Dynamics and mechanism of recombination of electron-hole plasma and high density excitons in CdS and CdSe.”

V. S Dneprovskii, V. I. Klimov, and M. G. Novikov

Moscow State University

Sov. phys. JFTP 72(3) March 1991 1991 American Institute of physics

Page 468˜Page476

“Parametric excitation of Alfven and helicon waves in magnetoactive compensated semiconductor by microwave radiation”

A. A. Mamun and M. Salimullah

Department of physics Jahangirnagar University

Physical Review B volume 44, Number 16 15 Oct. 1991

Page 8685˜8693

Photochemistry of colloidal Semiconductor. 20. Surface Modification and Stability of strong Luminescing CdS particles

Lubomir Spanhel, Markus Haase, Horst Weller and Arnim Henglein

Hahn-Metiner-Institute Berlin, Federal Republic of Germany

J. Am. Chem. Soc 1987, 109, Page 5649-Page5655

A mechanism of photo-luminescence by recombination electron and hole of semiconductor pigment of CdS and CdSe in light or electromagnetic field waves with semiconductor is shown in the article of V. S Dneprovskii, V. I. Klimov, and M. G. Novikov. When we irradiate microwave to semiconductor material with application of magnetic field, Alfven waves and helicon waves are induced by solid state plasma. This fact is shown in the article of A. A. Mamun and M. Salimullah.

The amplification of quantum efficiency of photo-luminescence by surface activation of CdS and CdSe semiconductor particles is shown in the article of Lubomir Spanhel, Markus Haase, Horst Weller and Arnim Henglein.

The energy of quantum fluid is amplified in quantum turbulent state in quantum vortices by gauge field plasmon by occurring quantum chaos in semiconductor material applied magnetic field. That is shown theoretically in following article but experimental test is not done yet.

Turbulence and Spatial Correlation of Currents in Quantum Chaos

John R. Evans and Mark I. Stockman

Department of Physics and Astronomy: Georgia State University

Physical Review letters volume 81 Number 21 23 Nov. 1998

Page 4624˜Page 4627

Perpetual periodic motion occurs of crest type vortices by reaction and diffusion of multiple chemicals. This fact is known as Belousov and Zabotinski reaction in following article.

A. N. Zaikin and A. M. Zabotinski, Nature, 225, 535-537(1970)

Quantum solution occurs in quantum kicked rotator in quantum chaos. Theoretical investigation of that is shown in following article but experimental proof is not done yet. As an example of quantum kicked rotator is shown in following patent, Japan Patent 4904528.

An invention of electric generator that we insert Argon gas and gold, silver, platinum, platinum rhodium of noble metal particles or rod, apply magnetic field using permanent magnet, heat them by microwave, milliwave or high frequency wave and cool by water, is disclosed as Japan patent number 4904528. This invention is based on the energy of magnetization deviation and magnetic resonance of ferrofluid interacting with plasma of Ar gas and plasmon of gold, silver, platinum, platinum rhodium of noble metal particles or rod. We can make electric generator rotating ferro-fluid with fins as disclosed Japan patent 4904528.

The energy amplification effects of quantum turbulence by occurring quantum chaos in superfluid phenomena of multiple phase of magnetic fluid mixing with semiconductor pigment are not disclosed. We make multiple phase of electromagnetic fluid mixing semiconductor pigment in the magnetic fluid of superfluid state. Charged materials are formed by redox reaction on the interface of surface activated material mixed with organic polyphenol and semiconductor pigment. Exciton is formed by recombination of hole and electron of semiconductor pigment and charged material on the surface of semiconductor pigment. The photosensitivity is amplified by aforementioned exciton and thus magnetoplasmon effect is induced. As a result of that the interaction of light or electromagnetic field waves and solid surface electrons of semiconductor pigment is enhanced. Quantum effect by coherent state by phases of magnetoplasmon waves interferences occurs and quantum turbulence of quantum chaos and quantum soliton by Alfven waves occur. As a result of that the energy of superfluid is amplified by perpetual cyclic motion.

### DESCRIPTION OF INVENTION

Superfluid is known as macroscopic quantum state of Bose-Einstein condensation in which fluid flows persistently as superfluid without any frictional loss in extreme low temperature. When we irradiate microwaves to multiple phase electromagnetic fluid, superfluid energy occurs. Aforementioned superfluid energy is occurred by Bose-Einstein condensation of magnetoplasmon effect of ferromagnetic, ferrimagnetic and metal particles and thus superfluid phenomena of quantum vortices occur.

Electromagnetic field of superfluid state is enhanced by magnetoplasmon effect of semiconductor pigment photosensitivity. The photosensitivity of semiconductor pigment is occurred by forming exciton recombining electron and hole of charged material on the surface of semiconductor pigment. The charged material is formed by redox reaction on the surface of semiconductor pigment and organic polyphenol mixing with surface activated material. Interactions of light, electromagnetic waves and surface electrons of semiconductor pigment occur. Quantum effect of coherent state of interferences by magnetoplasmon resonances waves and phase relations occur. The superfluid energy is amplified by quantum turbulence of occurring quantum chaos and quantum soliton of Alfven waves.

We mix ferromagnetic and ferrimagnetism particles mixing metal particles, compound or oxidized metal particles and immerse aforementioned mixed particles in red wine, cassis alcohol, grape juice and blueberry juice which include polyphenol, malic acid and citric acid with adding surface activated materials to diffuse that liquid and increase photo-enhancement sensibility. When we irradiate microwaves to aforementioned fluid liquid, paramagnetic particles, component or oxidized particles of Titan, Vanadium, Platinum, Stannum, Tungsten, Aluminum, Zyrconia, Neodymium, Molybdenum or Paradium or copper, Zinc, Silicon, Silver, Cadmium, Selenium, Stannum, Platinum, Stibium, Hydragyrum, Indium, Bismuth or Phosphorous, Oxidized compound of Mn, Ni, Cr, Fe, Co such as MnO₄, CrO₇, Fe₂O₃, CoO, NiO show magnetization.

Unpaired electrons by void of lattice of metal crystals are excited by magnetic resonance thus aforementioned metal particles show ferromagnetism. Si, SiC, SiO, C, Carbon fiber or activated carbon show ferromagnetization.

Copper particles are transformed to ferromagntism and attracted to permanent magnet in FIG. 1.

Titan particles are transformed to ferromagntism and attracted to permanent magnet in FIG. 6.

Zyrconia particles are transformed to ferromagntism and attracted to permanent magnet in FIG. 7.

SiC particles are transformed to ferromagntism and attracted to permanent magnet in FIG. 8-1.

SiO particles are transformed to ferromagntism and attracted to permanent magnet in FIG. 8-2.

Carbon fibers are transformed to ferromagntism and attracted to permanent magnet in FIG. 8-4.

The example of non magnetic (Not ferromagnetic) elements and their compound show Ferromagnetism is the article by Jungjoo Yoon, Liviu M. Mirica, T. Daniel P. Stack, Edward E Solomon.

Ferromagnetism transformation of Cu complex in organic solvent by superexchange interaction by irradiation of light is shown aforementioned article.

We immerse Mn—Zn ferrite micron size particles and micron size paramagnetic or diamagnetic particles without surface S-electron bonds and add surface activated material. When we irradiate microwaves (2.45 GHz, 500 W) to aforementioned particles liquid, particles of diamagnetic or paramagnetic show ferromagnetism by superexchange interaction.

This phenomena is caused by negative ion of polyphenol free radical electron and spin excitation of Mn—Zn ferrite particles. Electron bonds of d-electron, p-electron and f-electron of diamagnetic, paramagnetic micron size particles are induced by redox reaction by Mn—Zn ferrite particles and organic polyphenol and thus superexchange interaction occurs. As a result of that, paramagnetic particles, component or oxidized particles of Titan, Vanadium, Platinum, Stannum, Tungsten, Aluminum, Zyrconia, Neodymium, Molybdenum or Paradium and Copper, Zinc, Silicon, Silver, Cadmium, Selenium, Stannum, Platinum, Stibium, Hydragyrum, Indium, Bismuth or Phosphorous or Carbon of diamagnetic particles show ferromagnetism.

By adding surface activated materials to aforementioned metal particles liquid, reaction of surface electrons of diamagnetic or paramagnetic particles, negative ion of free radical electron of polyphenol, and spins of Mn—Zn ferrite particles are activated by microwave irradiation. As a result of that ferromagnetization of diamagnetic or paramagnetic particles by superexchange interaction becomes strong.

Electron bonds which show ferromagnetism by superexchange interaction are p electron bond, d-p electron bond, f-p electron bond, s-p electron bond. The elements which have s-electron bond only such as Ca, K, Na, Mg, Ba are not transformed to ferromagnetism. Ferromagnetism transformation by diamagnetic or paramagnetic metal particles by microwave spins excitation occurs by following reason. Electronic and magnetic interactions of intermetalic of diamagnetic particles, paramagnetic particles and Mn—Zn ferrite particles work cooperatively by polyphenol. Phase transitions from basis state occur by Zeeman effect and magnetic resonance, as a result of that phases of surface of diamagnetic or paramagnetic particles reach microwave excited sub-stable condition. In paramagnetic particles, component or oxidized particles of Titan, Vanadium, Platinum, Stannum, Tungsten, Aluminum, Zyrconia, Neodymium, Molybdenum and Paradium and copper, Zinc, Silicon, Silver, Cadmium, Selenium, Stannum, Platinum, Stibium, Hydragyrum, Indium, Bismuth or Phosphorous, Oxidized compound of Mn, Ni, Cr, Fe, Co such as MnO₄, CrO₇, Fe₂O₃, CoO, NiO, quantum effect of magnetoplasmon effects are varied by sizes of particles. The energy of the magnetic fluid including these particles is depended on sizes. Thus the big fluid energy of superfluid occurs.

When we irradiate microwaves to aforementioned magnetic fluid, semiconductor pigment and multiple phase electromagnetic fluid become quantum state. We explain theories of amplifying the energy of superfluid by quantum turbulence occurring quantum chaos.

When we irradiate microwaves to multiple phase electromagnetic fluid containing ferromagnetic or ferrimagnetic particles and ferromagnetized particles of paramagnetic or diamagnetic particles, magnetic resonances occur. Because of the interaction of spincyclotron resonance of ferromagnetized particles of paramagnetic or diamagnetic particles, and plasmon resonance of aforementioned surface of metal particles, magnetoplasmon resonance occurs thus states of particles resonance reach Bose-Einstein condensation. As a result of that microwave superfluid phenomena with quantum vortices in room temperature and room pressure occur like superconductivity or superfluidity. When we mix carbon fiber with ferromagnetic or ferrimagnetism particles and ferromagnetized particles of paramagnetic and diamagnetic and thus make multiple phase of electromagnetic fluid. When we irradiate microwaves to aforementioned electromagnetic fluid, non-equilibrium electromagnetic field from surface electrons emission of Carbon fiber particles is formed. Plasma is formed on the surface of the particles of carbon materials which are especially carbon fiber, activated carbon. Magnetoplasmon resonance by an interaction of plasma and spin-cyclotron resonance of ferromagnetized carbon fiber occurs. As a result of that superfluid phenomena with quantum vortices by microwave irradiation occurs in room temperature and room pressure such as superconductivity and superfluidity in extreme low temperature. We make multiple phase electromagnetic fluid adding semiconductor pigment which has photo-excitation quality by exciton to superfluid by microwave.

Charged material is formed by redox reaction on the interface of semiconductor pigment and organic polyphenol with surface activated material. Exciton is formed by recombination of electrons and holes of semiconductor pigment and charged material on the interface of semiconductor pigment. Thus photosensitivity is created, magnetoplasmon resonance occurs and electromagnetic field is enhanced. As a result of that, quantum coherent state by interferences effect of phases of magnetoplasmon resonances occurs by the interaction of surface electrons of semiconductor pigment and light or electromagnetic waves. Thus quantum effect occurs, quantum soliton motion by Alfven waves and quantum chaos occurs. As a result of that quantum turbulence occurs then the energy of superfluid is amplified.

When we irradiate microwaves to magnetic material in room temperature, parallel pumping occurs then Bose-Einstein condensation of macroscopic quantum effect such as superconductor and superfluidity is shown in the article of Author, V. E. Demitov, O. Dzyapko, S. O. Demokritov, G. A. Melkov and A. N. Slavin.

When we irradiate microwaves to magnetic material in room temperature, parallel pumping occurs and soliton motion is amplified. This is shown in the article Author B. A. Kalinikos, N. G. Kovshikov, and M. P. Kostylev.

When the model of magnetic fluid of low temperature plasma propagates perpendicular to magnetic field, Alfven wave and soliton wave are induced. This fact is described in Methods in Nonlinear Plasma theory by Ronald C. Davidson.

The mechanism of occurring plasma by exciton recombining electron and hole of CdS and CdSe of semiconductor pigment is shown in the article,

“Dynamics and mechanism of recombination of electron-hole plasma and high density excitons in CdS and CdSe.”

V. S Dneprovskii, V. I. Klimov, and M. G. Novikov

When we irradiate microwave to semiconductor material with application of magnetic field, Alfven waves and helicon waves are induced by solid state plasma. This fact is shown in the article of A. A. Mamun and M. Salimullah.

When we irradiate microwaves to ferrofluid containing ferromagnetism transformed metal particles and semiconductor pigment by applying magnetic field from outside, Alfven waves occur along with magnetic force lines perpendicular to the magnetic field then quantum chaos occurs.

When we irradiate microwaves to the magnetic fluid by applying strong magnetic field from outside, microscopic quantum effect of spins of many particles of the magnetic fluid is amplified macroscopically by Bose-Einstein condensation. The energy of magnetic fluid is amplified by input microwave energy by spin resonance and magnetic resonance. The amplified magnetic fluid energy is represented in equation (1).

B=H+h(sin ωt)

P=2πγMₛhgμ_{B}nₖ (1)

B; magnetic energy applied H; applied static magnetic field h; input microwave energy P; energy of magnetic fluid π; circular constant γ; gyromagnetic constant g; g factor μ_{B}; Bohr magnetic moment nk; excited spin numbers, Mₛ; spontaneous magnetization applied magnetic field of magnetic fluid

Paramagnetic particles, component or oxidized particles of Titan, Vanadium, Platinum, Stannum, Tungsten, Aluminum, Zyrconia, Neodymium, Molybdenum or Paradium and copper, Zinc, Silicon, Silver, Cadmium, Selenium, Stannum, Platinum, Stibium, Hydragyrum, Indium, Bismuth or Phosphorous and ferromagnetism particles Nickel, Manganese, Cobalt, Chrome or their oxidized particles transforms ferromagnetism particles, thus spin-cyclotron motion is induced and its frequency (spin-cyclotron) is represented equation (2).

$${ω}_{c} = \frac{eB}{m c}$$

ω_{c}; spin-cyclotron e; electric charge B; applied magnetic energy m; free electron mass c; speed of light

Paramagnetic particles, component or oxidized particles of Titan, Vanadium, Platinum, Stannum, Tungsten, Aluminum, Zyrconia, Neodymium, Molybdenum or Paradium and copper, Zinc, Silicon, Silver, Cadmium, Selenium, Stannum, Platinum, Stibium, Hydragyrum, Indium, Bismuth and Phosphorous and ferromagnetism particles Nickel, Manganese, Cobalt, Chrome and their oxidized particles transforms ferromagnetism particles, induce plasmon frequency in equation (3).

$${ω}_{p}^{2} = \frac{4 π n {e}^{2}}{m} \qquad ( 3 )$$

ωₚ plasmon frequency π; circular constant n; free electron density of particles m; mass of free electron

Paramagnetic particles, component or oxidized particles of Titan, Vanadium, Platinum, Stannum, Tungsten, Aluminum, Zyrconia, Neodymium, Molybdenum or Paradium and copper, Zinc, Silicon, Silver, Cadmium, Selenium, Stannum, Platinum, Stibium, Hydragyrum, Indium, Bismuth and Phosphorous and ferromagnetism particles Nickel, Manganese, Cobalt, Chrome and their oxidized particles transforms ferromagnetism particles, induce magnetoplasmon ω frequency in equation (4) by using spin-cyclotron frequency of equation ω_{c} equation (2) and plasmon frequency ωₚ equation (3).

$${ε}_{yz}^{Drude} = i \frac{{ω}_{c} {ω}_{p}^{2}}{ω [ {( ω + i / {τ}_{Dr} )}^{2} - {ω}_{c}^{2} ]} \qquad ( 4 )$$

ε_{yz}^{Drude}; permittivity, τ_{Dr}; Drude relaxtion time ω_{c}; spin-cyclotron frequency ωₚ; plasmon frequency i; imaginary number

Energy by magneto-plasmon excitation is in equation (5).

W=nω (5)

W; Energy by magneto-plasmon excitation n; number of magneto-plasmon excitation ; plank constant ω; magneto-plasmon frequency

The magnetoplasmon frequency of semiconductor pigment such as CdSe/CdS component particles, Ti O₂ particles is shown in equation 4

Exciton is excited by recombination of electron and hall of semiconductor pigment in photogeneration. As a result of that photosensitivity is induced. The photosensitivity is amplified by the electric field of magnetoplasmon. Spectrum of amplified photosensitivity is shown in equation (6).

$$I ( ℏω ) = {\frac{2 π}{ℏ} [ H ]}^{2} {f}_{e} ( \frac{ℏ ω - {E}_{g}}{1 + \frac{1}{β}} ) {f}_{h} ( \frac{ℏ ω - {E}_{g}}{1 + β} ) \frac{{2}^{\frac{1}{2}} {m}_{r}^{\frac{3}{2}}}{{π}^{2} {ℏ}^{3}} {( ℏ ω - {E}_{g} )}^{1 / 2} \\ β = {m}_{h} / {m}_{e} \\ {m}_{r} = \frac{{m}_{e} {m}_{h}}{{m}_{e} + {m}_{h}} \\ H = \frac{π {e}^{2} ℏ}{{m}_{e} {ɛ}_{∞} ω} {E}_{g} \qquad ( 6 )$$

I(ω); Spectrum of amplified photosensitivity of semiconductor pigment π; circular constant ; plank constant ω; magnetoplasmon frequency E_{g}; bandgap of semiconductor pigment fₑ; electron distribution function of semiconductor piment fₙ; hall distribution function of semiconductor pigment mₕ; hall mass of semiconductor pigment me; electron mass of semiconductor pigment

Electromagnetic energy of magnetoplasmon excitation of Ferromagnetizing noble metal, CdS/CdSe compound particles and TiO₂ compound particles is shown in equation 7.

$$E ( y , z , t ) = ( {E}_{y} + {iE}_{z} ) exp ( i ( ky - ω t ) - \frac{y}{2 L} )$$

E(y, z, t); Electromagnetic energy of magnetoplasmon excitation (y direction, z direction, t time),
E_{y}; Electromagnetic field of y direction E_{z}; Electromagnetic field of z direction i; imaginary number k; wavenumber of magnetoplasmon frequency ω; frequency of magnetoplasmon
L; magnetoplasmon propagation distance in y direction

Magnetic resonance energy of Mn—Zn magnetic fluid is shown in equation (1)

B(x.y.z)=H(x.y.z)+h(sin ωₕt)

P(x.y.z)=2πγ(Mₛ+H(x.y.z))hgμ_{B}nₖ=2πγ(Mₛ+B(x.y.z)−h(sin ωₕt))hgμ_{B}nₖ

B(x,y,z); Applied electromagnetic field energy of x direction, y direction, z direction
H(x,y,z); Applied static magnetic field of x direction, y direction, z direction
P(x,y,z); Mn—Zn ferrite particles excited energy of x direction, y direction, z direction

The Mn—Zn ferrite particles magnetic resonance energy interacts the electric field of noble metal and semiconductor pigment. Thus resulted quantum mechanical wave equation is shown in equation (8).

$$∅ = \frac{{P}_{( x . y . z )}}{2 π ℏ c} ∮ {d}_{r} \times E ( y . z . t ) \\ ∅ = \frac{g γ h {μ}_{B} {n}_{k}}{ℏ c} ( {M}_{s} + H ( x . y . z ) ) ∮ {d}_{r} \times E ( y . z . t ) \\ ∅ = \frac{g γ h {μ}_{B} {n}_{k}}{ℏ c} ( {M}_{s} - h sin ( {ω}_{h} t ) ) ∮ {d}_{r} \times E ( y . z . t ) + \frac{g γ h {μ}_{B} {n}_{k}}{ℏ c} ∮ d r ( {B}_{( x . y . z )} \times {E}_{( y . z . t )} ) \qquad ( 8 )$$

The quantum mechanical energy is shown in equation (9).

$$\frac{{P}^{2}}{2 m} ∅ = \frac{i ℏ \partial ∅}{\partial t} \qquad ( 9 )$$

Phenomena of the magnetic fluid occur when spin symmetry of ferromagnetic particles is broken. Phenomena of liquid crystal occur when symmetry of spin orbital space is broken by electric field. It is well known that superfluid phenomena occur when both spin symmetry of ferromagnetic particles and symmetry of spin orbital space by electric field is broken in the following articles; Advanced information on the Nobel Prize in Physics, 7 Oct. 2003

Kungl. Vetenskapsakademien

The royal Swedish academy of sciences.

Symmetry breaking of ferromagnetic particles' spins by magnetic resonance of equation (1) interacts spin orbital symmetry breaking by electric field of magnetoplasmon effect of ferromagnetism transformed noble metal and semiconductor pigment which is shown in equation 7. As a result of that microwave superfluid phenomena occur. Quantum mechanical energy of microwave superfluid is shown in equation (9).

The energy of quantum fluid is amplified in quantum turbulent state in quantum vortices by gauge field plasmon by occurring quantum chaos in semiconductor material applied magnetic field. That is shown theoretically in following article but experimental test is not done yet.

Turbulence and Spatial Correlation of Currents in Quantum Chaos

John R. Evans and Mark I. Stockman

From the equation (9) of quantum mechanical wave equation, quantum chaos occurs and the superfluid energy is amplified by quantum turbulence in the superfluid state in multiple phase magnetic fluid mixing semiconductor pigment and diamagnetic or paramagnetic metal particles which interact

magnetic resonance energy of Mn—Zn magnetic fluid.

When electromagnetic waves, microwaves and optical waves of different frequencies irradiate interchangeably to magnetic fluid containing ferromagnetic particles, ferromagnetism transformed particles of diamagnetic or paramagnetic and semiconductor pigment, microwave superfluid energy increases. The energy of microwave superfluid is decided law of energy (mass) acquiring theorem of Bose-Einstein condensation, magnetoplasmon effect applied magnetic field. An equation of energy (mass) acquiring principle by magnetoplasmon effect is shown in equation (10).

$$m \ddot{r} = \frac{Q}{c} \dot{r} \times B - {Q}^{2} ∇ ( \frac{{e}^{- \frac{L}{λ D}}}{L} ) \\ \dot{r} = r ω , \\ \ddot{r} = - r {ω}^{2} \qquad ( 10 )$$

m; mass of metal particles r; radius of metal particles B; applied all electromagnetic energy Q; electric charge ∇; gradient e; natural logarithm constant
L; y direction excited electric field by magnetoplasmon effect λD; Debye length ω; magnetoplasmon frequency

The second term of equation (2) is potential electromagnetic wave energy (Yukawa potential) which is acquired by magnetoplasmon effect. The radius r of metal particles is decided by equation (10) as a result of that, optimal size of metal particles are derived.

The quantum turbulence occurs by quantum soliton and quantum chaos by Alfven waves in microwave superfluid. Thus the energy of microwave superfluid energy increases.

The principle of occurring Alfven waves of electromagnetic fluid is stated in

“Introductory to magnetohydrodynamic/plasma

Author V. C. A. Ferraro and C. Plumpton

In the book of V. C. A. Ferraro and C. Plumpton, longitudinal wave is occurring in electromagnetic fluid of compressible fluid. If the velocity of particles and propagation of waves are parallel to magnetic, normal surface sonic waves occur. Because fluid particles parallel to magnetic field never disturbs magnetic force line. Such waves propagate in fluid by normal sound velocity C₀. If velocity of particles parallel to propagation but perpendicular to magnetic field, static pressure by magnetic pressure and normal static pressure of fluid are added, thus second form of longitudinal compressible waves which are discovered by Alfven occur. In this case, the velocity of sound is (C₀+μH₀²/ρ)^{1/12}

C₀; velocity of sound, μ; permittivity, H₀; magnetic field, ρ; density

When we irradiate microwaves to magnetic particles, ferromagnetism transformed metal particles semiconductor pigment by applying magnetic field, Alfven waves by quantum effect of electron spins of magnetic particles and ferromagnetism transformed metal particles. The exciton is formed by recombining electron and hole of semiconductor pigment and charged surface material. The Alfven waves is occurred by magnetoplasmon oscillation by photosensitivity which is created by exciton. Quantum soliton motion is occurred by Alfven waves. We applied magnetic field to multiple phase magnetic fluid by placing permanent magnets from side and bottom of container which includes aforementioned magnetic fluid. As a result of that, 2 kinds of Alfven waves which are perpendicular to the magnetic field of 2 placing magnets and soliton motion occurs along the magnetic force line. 2 kinds of Alfven waves and soliton motion crushes each other, as a result of that, shock waves condition is observed.

The velocity of Alfven waves of magnetic particles and ferromagnetism transformed metal particles is shown in equation 11.

V_{da}=B/(μ_{Bmb}n_{b})^{1/2} (11)

V_{da}; velocity of Alfven waves of particles which have spontaneous magnetization B; applied all electromagnetic field energy μ_{B}; Bohr magnetic constant m_{b}; mass of particles of spontaneous magnetization n_{b}; density of particles which have spontaneous magnetization

The velocity of Alfven waves of semiconductor pigment is shown in equation 12.

Vₐ=B/(4πn₀mₕ)^{1/2} (12)

Vₐ; velocity of Alfven waves of semiconductor pigment B; applied electromagnetic field energy n₀; density of semiconductor pigment

When we inject gas into the superfluid condition of magnetic fluid and irradiate microwaves to gas injected superfluid by applying strong magnetic field using permanent magnet, Plasma is formed by gas, and superfluid condiction becomes sub-critical fluid. When gas is injected with microwave application and magnetic field application in ferromagnetism transformed paramagnetic particles, component or oxidized particles of Titan, Vanadium, Platinum, Stannum, Tungsten, Aluminum, Zyrconia, Neodymium, Molybdenum and Paradium and copper, Zinc, Silicon, Silver, Cadmium, Selenium, Stannum, Platinum, Stibium, Hydragyrum, Indium, Bismuth or Phosphorous and ferromagnetism particles Nickel, Manganese, Cobalt, Chrome or their oxidized particles and MnO₄, CrO₇, Fe₂O₃, CoO, NiO with ferromagnetic Mn—Zn particles mixing with semiconductor pigment particles liquid, plasma is formed and reach subcritical fluid condition. Thus multiple phase magnetic fluid energy is amplified by quantum plasma and lorentzian electromotive force.

Lorentzian electromotive force of quantum plasma with quantum vortex in superfluid condition is shown in equation (10).

$$S = \frac{1}{{μ}_{0}} \int ( \frac{∇ {P}_{e}}{en} + \frac{{F}_{Q}}{en} + \frac{{R}_{e}}{en} ) \times B d a$$

S; lorentzian electromotive force μ₀/permeability of space ∇Pₑ; pressure of superfluid F_{Q}; quantum mechanical force of spin effect Re; superfluid of plasma B; applied magnetic field e; electric charge n; electron density

$$∇ {P}_{e} = {m}_{i}$$

$${C}_{s}^{2} ∇ {n}_{e}$$

$${C}_{s} = {( \frac{{T}_{e}}{{m}_{i}} )}^{1 / 2}$$

mi; ion mass Cs; ion velocity n_{c}; electron density Te; electron temperature

$${F}_{Q} = \frac{{n}_{e} {ℏ}^{2}}{2 {m}_{e}} ∇ ( \frac{{∇}^{2} \sqrt{{n}_{e}}}{\sqrt{{n}_{e}}} ) + {μ}_{B} {n}_{e} tanh ( \frac{{μ}_{B} B}{{T}_{e}} ) ∇ B$$

mₑ; electron mass, nₑ; electron density, ; plank constant, μ_{B}; Bohr magnetic constant, Tₑ; electron density, B; applied strong magnetic energy

Rₑ=−Rᵢ=enηJₚη=mₑνₑᵢ/n₀e²Jₚ=Σ_{s=e,j}qₛnₛvₛ

e; electric charge density, n; density, π; plasma resist loss, me; electron mass, νei; electron-mass ion frequency
Jₚ; plasma density, qs; plasma charge (s=e; electron, s=i; ion) n s, plasma density (s=e; electron, s=i; ion) vs; plasma velocity (s=e; electron, s=i; ion)

When we irradiate microwaves to aforementioned magnetic fluid by applying strong magnetic field, Bose-Einstein condensation by quantum spins occur. As a result of that microscopic quantum effect of spin effects are amplified to macroscopic quantum effect, thus the energy of the magnetic fluid is amplified by magnetic resonance as input microwave energy.

Magnetoplasmon effect of ferromagnetizing paramagnetic particles, component or oxidized particles of Titan, Vanadium, Platinum, Stannum, Tungsten, Aluminum, Zyrconia, Neodymium, Molybdenum or Paradium and copper, Zinc, Silicon, Silver, Cadmium, Selenium, Stannum, Platinum, Stibium, Hydragyrum, Indium, Bismuth and Phosphorous and ferromagnetism particles Nickel, Manganese, Cobalt, Chrome or their oxidized particles or MnO₄, CrO₇, Fe₂O₃, CoO, NiO with ferromagnetic Mn—Zn particles mixing with semiconductor pigment particles and quantum plasma effect of ionized gas interacts each other. As a result of that input microwaves energy acquires energy (mass) by application of magnetic field from outside, thus lorentzian electromotive force occurs.

I tested reaction of absorption of visible light range of metal particles and photosensitivity which causes superfluid phenomena of microwave region.

We used semiconductor pigments of Copper compound and tested differences of quantum vortex of Bose-Einstein condensation by colors of copper compound. As a result of that actions and phenomena of quantum vortices are greatly deviated. The relation of 2.45 GHz of microwaves and absorption wavelength with absorption and reflection related to colors of copper compound makes differences of energy of quantum vortices.

When we observe an experiment (4) of Mn—Zn ferrite particles, Cu and Azurite (Cu₃(Co₃)OH₂), spin excitations rarely exist in blue color absorption wavelength (340 nm˜470 nm) in FIG. 4-1, thus magnetoplasmon effect is small. On contrary, the red color of semiconductor pigment CdS/CdSe exists from 600 nm to 740 nm and absorption wavelength exists from 300 nm to 650 nm. Big magnetoplasmon effect exists in 2.45 GHz microwave region. Charged material is formed on the interface of semiconductor pigment of CdS/CdSe by redox reaction. The photosensitivity is occurred by exciton combining electrons and holes of semiconductor pigment with charged material on the surface of semiconductor pigment. Thus magnetoplasmon resonance is induced and electromagnetic field is enhanced by interaction of light or electromagnetic waves and surface electrons of solid state. Quantum vortices occur by coherent quantum effect by the interference of electromagnetic waves of magnetoplasmon resonances. Thus quantum turbulence occurs by Alfven waves of quantum soliton and quantum chaos as a result of that superfluid state energy is amplified greatly.

Experiment 8 is an experiment in which Bismuth particles are added to Copper particles of experiment 1. As a result of experiment 8, quantum vortices occur. Bismuth has 50% absorption wavelength from 450 nm to 550 nm. When we apply magnetic field to multiple phase of magnetic fluid of experiment 8, Quantum vortices of magnetoplasmon effect is observed in 2.45 GHz. Experiment 9 is following, we mix Mn—Zn ferrite particles (average size 20 μm) 5 g and Titan particles (average particle size 10 μm) 5 g inserted in heat resistance glass which contains red wine 50 cc with surface activated material 5 cc. After that we irradiate microwaves aforementioned particles in heat resistance glass by microwave oven (2.45 GHz, 500 W). Crest of quantum vortices is observed. Titan particles have 50% absorption wavelength from 350 nm to 430 nm. When we apply magnetic field and irradiate microwaves to aforementioned multiple phase particles of Titan with liquid, quantum vortices are observed in magnetoplasmon effect in 2.45 GHz microwaves. Experiment 10 is following, we mix Mn—Zn ferrite particles (average size 20 μm) 5 g and Vanadium particles (average particle size 10 μm) 5 g inserted in heat resistance glass which contains red wine 50 cc with surface activated material 5 cc. Then we irradiate microwaves to aforementioned particles with liquid by microwave oven (2.45 GHz, 500 W) with 30 seconds. The crest of quantum vortices is observed. The Vanadium particles have 30% absorption wavelength from 350 nm to 450 nm. When we apply magnetic field to aforementioned particles with liquid, magnetoplasmon effect is observed in 2.45 GHz microwaves and quantum vortices are observed. Experiment 11 is following, we mix Mn—Zn ferrite particles (average size 20 μm) 5 g and Zirconium particles (average particle size 10 μm) 5 g inserted in heat resistance glass which contains red wine 50 cc with surface activated material 5 cc. Then we irradiate microwaves to aforementioned particles with liquid by microwave oven (2.45 GHz, 500 W) with 30 seconds. The crest of quantum vortices is observed. The Zirconium particles have 30% absorption wavelength from 350 nm to 450 nm. When we apply magnetic field to aforementioned particles with liquid, magnetoplasmon effect is observed in 2.45 GHz microwaves and quantum vortices are observed.

The energy of light is deviated by wavelength. Paramagnetic particles, component or oxidized particles of Titan, Vanadium, Platinum, Stannum, Tungsten, Aluminum, Zyrconia, Neodymium, Molybdenum or Paradium and copper, Zinc, Silicon, Silver, Cadmium, Selenium, Stannum, Platinum, Stibium, Hydragyrum, Indium, Bismuth or Phosphorous and ferromagnetism particles Nickel, Manganese, Cobalt, Chrome and their oxidized particles have peculiar absorption wavelength. The absorption wavelength is visible right region. The color of black is total electromagnetic waves absorber. The visible right, blue violet wavelength is about 380 nm and red light is about 780 nm. The energy volt of violet is 2.755 eV and red light is 1.650 eV. The energy difference is 1.7 times. When we irradiate microwaves and apply magnetic field to multiple phase magnetic fluid consisted of ferromagnetic particles and ferromagnetism transformed paramagnetic particles, component or oxidized particles of Titan, Vanadium, Platinum, Stannum, Tungsten, Aluminum, Zyrconia, Neodymium, Molybdenum and Paradium and copper, Zinc, Silicon, Silver, Cadmium, Selenium, Stannum, Platinum, Stibium, Hydragyrum, Indium, Bismuth or Phosphorous and ferromagnetism particles Nickel, Manganese, Cobalt, Chrome and their oxidized particles or MnO₄, CrO₇, Fe₂O₃, CoO, NiO, superfluid condition appears. The magnetic field is enhanced by magnetic resonance of multiple phase magnetic fluid of equation (1) and spin cyclotron resonance of aforementioned particles of equation (2).

The electric field is enhanced by plasmon resonance of aforementioned particles. The electromagnetic field is enhanced by the magnetoplasmon resonance frequency and plasmon resonance frequency of equation (4) by application of the magnetic field and interference interaction occurs. Quantum vortices by Bose-Einstein condensation is observed in multiple phase magnetic fluid which contains red color particles in 2.45 GHz microwave. Thus superfluid condition is created. Quantum vortices by Bose-Einstein condensation is observed in multiple phase magnetic fluid which contains blue violet color particles in higher frequency 2.45 GHz microwave such as 19 GHz or 23 GHz. Thus superfluid condition is created. The magnetoplasmon frequency of multiple phase magnetic fluid consisting of blue violet particles is higher frequency that that of red color particles in equation 4. Created energy by microwave superfluid of multiple phase magnetic fluid of blue violet particles are larger than that of red color particles in equation 5.

The colors of semiconductor pigment are deviated by particle sizes. Cu azurite is blue color and Cu malachite is green color not normal copper color. The color of Cd compound is greatly deviated from yellow to orange. When we irradiate microwaves to Cd compound, band gap and energy volt is greatly deviated in color. Copper compound such as Azurite is blue color and Malachite is green color. Cd compound is also greatly deviated by color from yellow to red. The bandgap occurred by microwave irradiation is greatly deviated. The energy-volt is deviated by color. The superfluid energy of microwave wavelength is enhanced by photosensitivity. The light interference is deviated by colors of mixing liquid, colors of paramagnetic or diamagnetism particles and semiconductor pigment.

The crest of quantum vortices by Bose-Einstein condensation is not observed by multiple phase magnetic fluid consisting of Ag, Zn, Al and Sn particles in microwave 2.45 GHz. If we change magnetic field and microwaves frequency, multiple phase magnetic fluid consisting of Ag, Zn, Al and Sn particles synchronizes by equation 2, equation 3 or equation 4.

W, Carbon or Carbon fiber have black color and they are total electromagnetic waves absorber. We mix W, Carbon or Carbon fiber of 5 g with Mn—Zn ferrite particles 5 g placed in heat resistance glass which contains red wine adding surface activated material and microwaves are irradiated by microwave oven for 30 seconds. After taking out aforementioned heat resistance glass, we apply magnetic field using permanent magnet from the bottom of heat resistance glass. Crest of quantum vortices are not observed in mixing W and Mn—Zn ferrite particles liquid because W is black color and total electromagnetic waves absorber. Plasma reaction is observed during microwave irradiation in microwave oven and quantum vortices by Bose-Einstein condensation are observed in Carbon fiber, Carbon compound and activated Carbon by application of magnetic field after taking them out from microwave oven. Non-equilibrium electromagnetic field and plasma reaction is observed in Carbon fiber, Carbon compound and activated Carbon by microwave irradiation and quantum vortices by Bose-Einstein condensation is observed.

In experiment 18, We mix Mn—Zn ferrite particles (average 20 μm, 5 g) with Carbon fiber, Activated Carbon and Carbon compound, Cu particles and also CdS/CdSe semiconductor pigment placed in heat resistance glass which contains 50 cc wine adding 5 cc surface activated material. Then we scramble and heat it using microwave oven for 30 seconds. As a result of that, non-equilibrium electromagnetic field is occurred and plasma reaction is observed in multiple phase magnetic fluid containing Activated Carbon and Carbon compound Carbon fiber. When we apply magnetic field after taking out it from microwave oven from the bottom of the vessel, hard quantum vortices of Bose-Einstein condensation occur thus hard fluid phenomena is observed.

When we immerse carbon particles which are made of carbon fiber and activated carbon in multiple phase magnetic fluid and irradiate microwaves to them and apply magnetic field, carbon particles which are made of carbon fiber and activated carbon transform to ferromagnetism. Spin cyclotron resonance is induced in ferromagnetism transformed carbon particles and non equilibrium electromagnetic field is formed on carbon particles by surface electrons. Thus the energy of superfluid is enhanced.

When red wine, red apple juice, blue berry liquor, blue berry juice, cassis are fermented, containment rate of polyphenol increases 1.5 times or more. When we insert Titan, Vanadium, Platinum, Stannum, Tungsten, Aluminum, Zyrconia, Neodymium, Molybdenum or Paradium and copper, Zinc, Silicon, Silver, Cadmium, Selenium, Stannum, Platinum, Stibium, Hydragyrum, Indium, Bismuth or Phosphorous and ferromagnetism particles Nickel, Manganese, Cobalt, Chrome and their oxidized particles and MnO₄, CrO₇, Fe₂O₃, CoO, NiO particles in fermented wine, blueberry, cassis mixing ferromagnetic particles then we irradiate microwaves to them, ferromagnetism transformation increases. The propelling power and velocity of quantum vortices of Bose-Einstein condensation shows large. The larger amount of polyphenol, the energy of superfluid is larger. Kinds of flavonoid which are contained in red wine, red apple juice, blue berry liquor, blue berry juice, cassis are catechin and anthocyanin. From aforementioned experimental result, the superfluid energy of microwave region is enhanced by photosensitivity that is also explained by experiment 16 and experiment 17. The energy of superfluid phenomena in microwave region is amplified by photosensitivity.

We mix kinds of diamagnetic or paramagnetic particles with ferromagnetic particles and semiconductor pigment in organic polyphenol liquid added surface activated material and thus make multiple phase magnetic fluid. When we irradiate microwaves (2.45 GHz, 500 W) to aforementioned multiple phase magnetic fluid for 40 seconds, photosensitivity of surface of diamagnetic or paramagnetic particles is activated on the interface between polyphenol liquid and metal surface.

As a result of that, aforementioned diamagnetic or paramagnetic metal particles are transformed to ferromagnetism. Magnon excitation and plasmon excitation of ferromagnetism transformed metal particles, ferromagnetic particles and semiconductor pigment induce peculiar frequencies plasmon oscillation and spin cyclotron oscillation by quantum excitation thus quantum turbulence is observed.

Charged material is formed on the interface of semiconductor pigment and organic polyphenol with surface activated material by redox reaction and photoelectric effect.

Electron and hole of semiconductor pigment and charged material on the interface of semiconductor pigment are recombined and form exciton, and thus photoelectric effect is induced. The photosensitivity by exciton is enhanced by the electromagnetic energy of magnetoplasmon oscillation and excitation. Thus when we mix semiconductor pigment in multiple phase magnetic fluid containing ferromagnetic particles and ferromagnetism transformed metal particles, large quantum turbulence is observed by light interference of metal surface. When we irradiate microwaves and apply magnetic field to the multiple phase magnetic fluid containing ferromagnetic particles, ferromagnetism transformed metal particles and semiconductor pigment, Alfven waves are induced by quantum effects of spins in ferromagnetic particles and ferromagnetism transformed metal particles. Exciton is formed by recombination of electron and hole of semiconductor pigment and charged materials. Alfven waves are induced by photosensitivity of magnetoplasmon oscillation. Quantum turbulence is induced in occurring quantum chaos in superfluid phenomena in multiple phase of magnetic fluid containing ferromagnetic particles, ferromagnetism transformed metal particles and semiconductor pigment. As a result of that superfluid energy is amplified.

The semiconductor material for amplification of superfluid energy in which aforementioned multiple phase magnetic fluid is exciton induced photosensitive materials. The examples of semiconductor compound are following III-V semiconductor compound (B,Al,Ga,In)(N,P,As,Sb), II-IV semiconductor compound (Mg,Zn,Cd,Hg)(O,S,Se,Te) and IV-VI semiconductor compound (Sn,Pb)(S,Se,Te).

We inject gas to the superfluid condition recited in claim 1, irradiate microwaves and apply magnetic field. As a result of that aforementioned superfluid reaches subcritical fluid by plasma of gas. There is a magnetohydrodynamics generator (MHD generator) which uses liquid metal and ionized plasma. The energy of aforementioned MHD generator increases in 40% by changing shape or gradient of fluid tube, becoming compressible electric fluid and becoming subsonic or supersonic waves and becoming compressible fluid by electromagnetic field. Aforementioned fact is recited in MIT core-curriculum,

Electrodynamics III Author, R. H. Woodson, J. R. Melcher.

When low temperature plasma magnetohydrodynamics model propagates perpendicular to magnetic field, Alfven waves and soliton waves occur, this fact is known in; Methods in Nonlinear Plasma theory Ronald C. Davidson

University of Maryland College Park, Maryland Academic Press

Volume 37 in pure and applied physics

A series of Monograph and Textbooks

Chapter 2. The Korteweg-de Vries Equation

A weakly Nonlinear theory of ion sound waves page 15 to page 31.

We make non-linear structure by fluid path tube of multiple phase magnetic fluid in which is subcritical and superfluid condition and make non-uniform electromagnetic filed by applying space gradient magnetic field. Thus, Alfven waves occur by compressible longitudinal plasma waves and electromagnetic wave energy is enhanced by quantum spin vortices of Bose-Einstein condensation of superfluid using microwaves and macroscopic quantum effect as quantum tunneling. Shock waves occur by Alfven waves and ferromagnetic resonance of superfluid.

We insert typical value (Tₑ=3 eV, B=0.5 T) to first term of equation 13—∇Pₑ and second

$$term tanh ( \frac{{μ}_{B} B}{{T}_{e}} ) . \\ Resulting tanh ( \frac{{μ}_{B} B}{{T}_{e}} ) = - 0.45 .$$

Because its value is negative, energy and electromotive force is amplified by magnetic nozzle, aforementioned magnetic fluid is accelerated to sub-Alfven to super-Alfven waves.

Perpetual periodic motion occurs of crest type vortices by reaction and diffusion of multiple chemicals. This fact is known as Belousov and Zabotinski reaction in following article.

A. N. Zaikin and A. M. Zabotinski, Nature, 225, 535-537(1970)

Electric conductivity, heat conductivity, coercivity density and diffusion velocity drastically changes in the multiple phase of magnetic fluid in superfluid condition. The energy of cyclic soliton motion is enhanced because multiple phase magnetic fluid is compressed and diffused by applying magnetic field and forming shapes of tube fluid.

### BRIEF DESCRIPTION OF DRAWINGS

FIG. 1 is a picture from the top of crest of quantum vortices of Bose-Einstein condensation in experiment 1. We can observe the crest of quantum vortices of Bose-Einstein condensation by application of permanent magnets.

FIG. 2 is a picture from the top of crest of quantum vortices of Bose-Einstein condensation in experiment 2. We can observe the crest of quantum vortices of Bose-Einstein condensation by application of permanent magnets.

FIG. 3 is a picture from the top of crest of quantum vortices of Bose-Einstein condensation in experiment 3. We can observe the crest of quantum vortices of Bose-Einstein condensation by application of permanent magnets. Quantum turbulent by occurring quantum chaos is observed. The cyclic continuity of quantum turbulence and quantum vortices by occurring quantum chaos is observed.

FIG. 4-1 is top picture of experiment 4 of Mn—Zn ferrite particles, Cu particles, Azurite particles. The crest of quantum vortices of Bose-Einstein condensation is not observed.

FIG. 4-2 is top picture of experiment 6 of Mn—Zn ferrite particles, Cu particles, malachite particles. The crest of quantum vortices of Bose-Einstein condensation is observed.

FIG. 5 is a picture from the top of crest of quantum vortices of Bose-Einstein condensation in experiment 7. We can observe the crest of quantum vortices of Bose-Einstein condensation by application of permanent magnets.

FIG. 6 is a picture from the top of crest of quantum vortices of Bose-Einstein condensation in experiment 9. We can observe the crest of quantum vortices of Bose-Einstein condensation by application of permanent magnets.

FIG. 7 is a picture from the top of crest of quantum vortices of Bose-Einstein condensation in experiment 11. We can observe the crest of quantum vortices of Bose-Einstein condensation by application of permanent magnets.

FIG. 8-1 is a picture of ferromagnetism transformed SiC, quantum vortices are not observed.

FIG. 8-2 is a picture of ferromagnetism transformed SiO₂, quantum vortices are not observed.

FIG. 8-3 is a picture of ferromagnetism transformed Cu.

FIG. 8-4 is a picture of ferromagnetism transformed Carbon fiber.

FIG. 9-1 is light absorption graph of Cu. Au and Silver

FIG. 9-2 is light absorption graph of CdSe/CdS semiconductor pigment

FIG. 9-3 is light absorption graph of TiO₂ and Bi₂O₃

FIG. 10 is the structure of occurring Alfven waves of superfluid

FIG. 10-1 is side figure of FIG. 10

FIG. 10-2 is top figure of FIG. 10

### DESCRIPTION OF EXPERIMENT AND PREFERRED EMBODIMENT

### Experiment 1

Mn—Zn ferrite particles (average size 20 μm) 5 g with, Cu particles (average size 10 μm) 5 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 54° C.

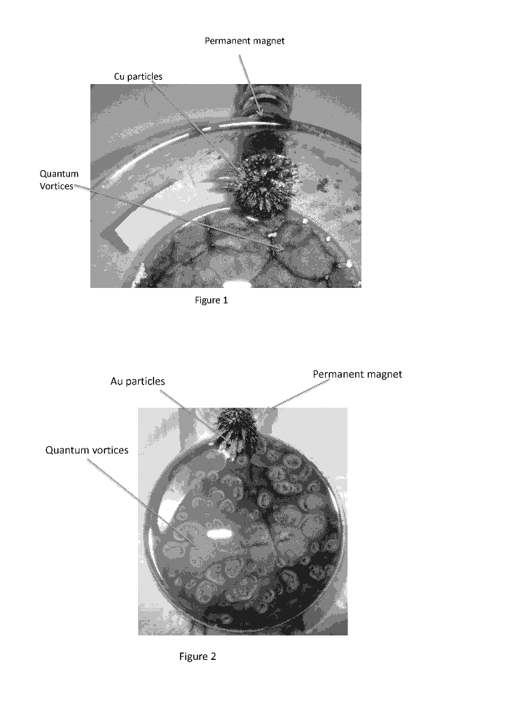

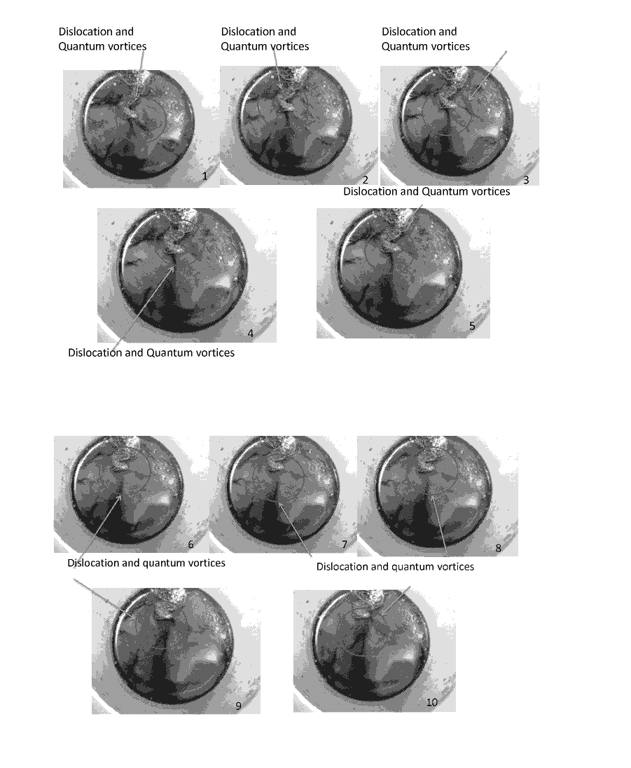

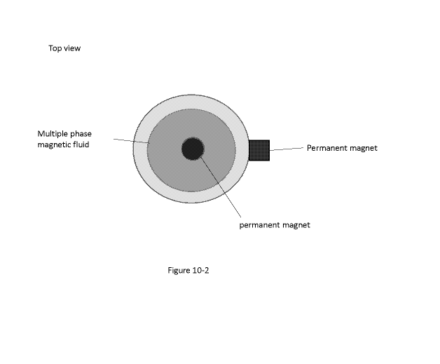

When we applied magnetic field using strong Neodymium magnet to aforementioned heat resistant glass as shown in FIG. 1, Cu particles magnetized spontaneously and make fluid phenomena. Crests of quantum vortices of Bose-Einstein condensation occur and move upward and downward. The motions of quantum vortices continue for 9 minutes. The structure of occurring quantum vortices is shown in FIG. 10. Alfven waves occur perpendicular to magnetic force lines. The motions of Alfven waves continue cyclically by quantum soliton motion. The crests of quantum vortices in FIG. 1 are measured average 5 cycles in 10 seconds. The crests quantum vortices of copper particles are shown in FIG. 1.

Following all experiments from experiment 1 to experiment 19, we use microwave oven (2.45 GHz) 500 W, surface activated material; di-ethyl-sulfonic-succinic-acid and Neodymium magnet diameter 5 mm and thickness 5 mm.

### Experiment 2

Mn—Zn ferrite particles (average size 20 μm) 5 g with, Au particles (average size 10 μm) 5 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 57° C.

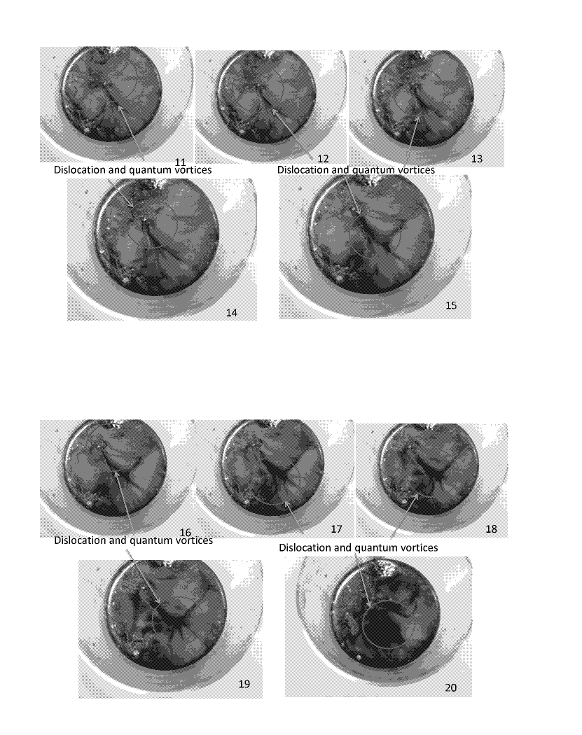

When we applied magnetic field using strong Neodymium magnet to aforementioned heat resistant glass as shown in FIG. 2, Au particles magnetized spontaneously and make fluid phenomena. Crests of quantum vortices of Bose-Einstein condensation occur and move upward and downward. The motions of quantum vortices continue for 9 minutes. The structure of occurring quantum vortices is shown in FIG. 10. Alfven waves occur perpendicular to magnetic force lines. The motions of Alfven waves continue cyclically by quantum soliton motion. The crests of quantum vortices in FIG. 2 are measured average 6 cycles in 10 seconds. The crests quantum vortices of gold particles are shown in FIG. 2.

### Experiment 3

Mn—Zn ferrite particles (average size 20 μm) 5 g with, Cu particles (average size 10 μm) 5 g and CdS/CdSe particles of red color (average size 20 μm) 5 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 53° C.

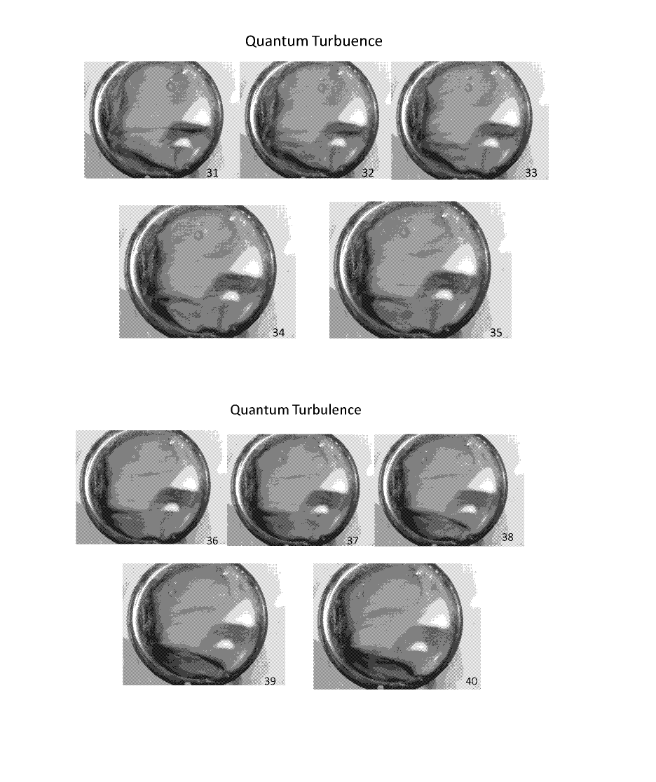

When we applied magnetic field using strong Neodymium magnet to aforementioned heat resistant glass as shown in FIG. 1. Crests of quantum vortices of Bose-Einstein condensation occur and larger than those of experiment 1 and 2 as shown in FIG. 3. The structure of occurring quantum vortices is shown in FIG. 10. Alfven waves occur perpendicular to magnetic force lines. The motions of Alfven waves continue cyclically by quantum soliton motion. The crests of quantum vortices in FIG. 2 are measured average 10 cycles in 10 seconds. The crests of quantum vortices of occurring of quantum chaos and quantum turbulence continues cyclically over 15 minutes. Pictures of FIG. 10 are continuous pictures of quantum vortices which are 5 pictures during 3 seconds period. Large vortices convection of Cu particles and CdS/CdSe particles occurs. We apply static magnetic field using permanent magnet from bottom of glass and side of glass from top view of pictures. The cyclic Alfven wave perpendicular of magnetic flux of side magnet of glass crushes the cyclic Alfven wave perpendicular of magnetic flux of bottom as a result of that dislocation by shock wave caused by crush of Alfven waves occurs.

Picture1 to picture 60 are the continuous pictures of 5 pictures during 3 seconds of 1 set. Picture1 to Picture5, Picture 6 to Picture 10, Picture 11 to picture 15, picture 16 to picture 20, picture 31 to picture 35, picture 36 to picture 40, picture 41 to picture 45, picture 56 to picture 60 are 1 set of 5 pictures. The photograph time is during 5 minutes. Big dislocation of black color Mn—Zn ferrite particles about the bottom portion of glass by applying magnetic field interacts with quantum vortices. As a result of that large convection of quantum vortices occurs. Larger superfluid energy than experiment 1 is created.

Fluid vortices rotate clockwise in a central attractor of quantum vortices and dislocation. As a result of that quantum chaos occurs.

Quantum turbulence occur by quantum chaos in total glass in continuous pictures from 31 to 40

after 1 minutes of picture 11 to picture 20. Quantum vortices convection occurs from bottom of glass.

Large vortices flow of quantum turbulence by occurring quantum chaos passed in continuous pictures 41 to pictures 45. They passed pictures from 56 to 60 and return to initial size of vortex flow. The energy of superfluid is amplified quantum turbulence phenomena and it continues cyclic as quantum mechanical phenomena.

### Experiment 4

Mn—Zn ferrite particles (average size 20 μm) 5 g with, Cu particles (average size 10 μm) 5 g and Azurite of blue color semiconductor pigment 5 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 53° C.

When we applied magnetic field using strong Neodymium magnet to aforementioned heat resistant glass, crest of quantum vortices of Bose-Einstein condensation occur and smaller than experiment 1. The motions of quantum vortices are measured 2 cycle for 10 seconds. The structure of occurring quantum vortices is shown in FIG. 10. Alfven waves occur perpendicular to magnetic force lines. The motions of Alfven waves continue cyclically by quantum soliton motion.

### Experiment 5

Mn—Zn ferrite particles (average size 20 μm) 5 g with, Cu particles (average size 10 μm) 5 g and malachite of blue color semiconductor pigment 5 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 53° C.

When we applied magnetic field using strong Neodymium magnet to aforementioned heat resistant glass, crest of quantum vortices of Bose-Einstein condensation occur as shown and larger than experiment 1. The motions of quantum vortices are measured 6 cycle for 10 seconds. The structure of occurring quantum vortices is shown in FIG. 10. Alfven waves occur perpendicular to magnetic force lines. The motions of Alfven waves continue cyclically by quantum soliton motion.

### Experiment 6

Mn—Zn ferrite particles (average size 20 μm) 5 g with, Cu particles (average size 10 μm) 5 g, azurite of blue color semiconductor pigment 5 g and malachite of blue color semiconductor pigment 5 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 53° C.

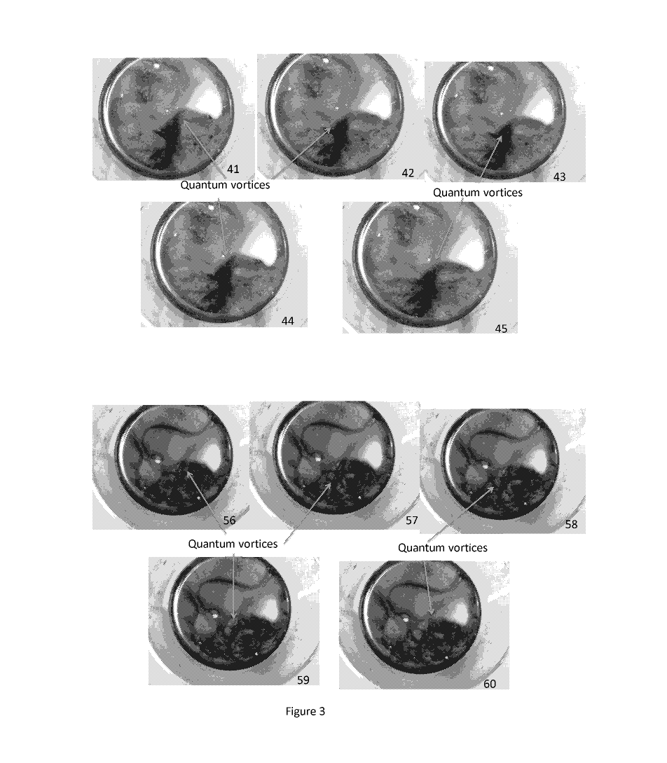

When we applied magnetic field using strong Neodymium magnet to aforementioned heat resistant glass, crests of quantum vortices of Bose-Einstein condensation are observed in FIG. 4-2 move upward and downward larger than experiment 1 and experiment 4. The motions of quantum vortices are measured 9 cycles for 10 seconds. The structure of occurring quantum vortices is shown in FIG. 10. Alfven waves occur perpendicular to magnetic force lines. The motions of Alfven waves continue cyclically by quantum soliton motion.

### Experiment 7

Mn—Zn ferrite particles (average size 20 μm) 5 g with, Cu particles (average size 10 μm) 5 g, adding Au particles 2 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 54° C.

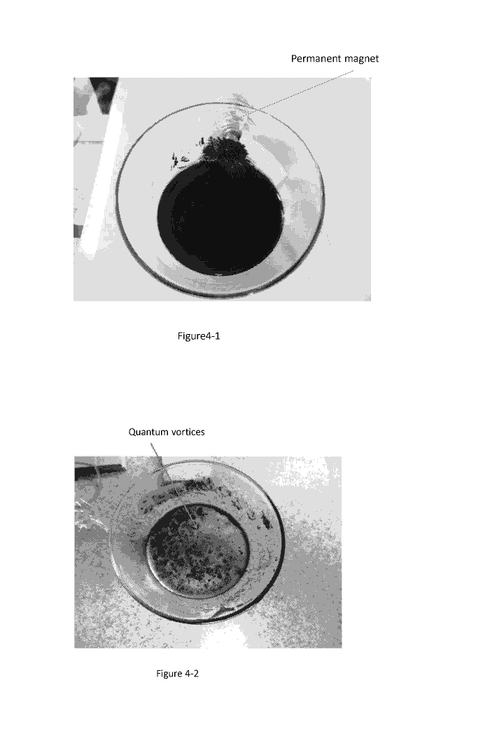

When we applied magnetic field using strong Neodymium magnet to aforementioned heat resistant glass, crests of quantum vortices of Bose-Einstein condensation are observed in FIG. 5 move upward and downward larger than experiment 1. The motions of quantum vortices are measured 9 cycles for 10 seconds and continue for 15 minutes. The structure of occurring quantum vortices is shown in FIG. 10. Alfven waves occur perpendicular to magnetic force lines. The motions of Alfven waves continue cyclically by quantum soliton motion.

### Experiment 8

Mn—Zn ferrite particles (average size 20 μm) 5 g with, Cu particles (average size 10 μm) 5 g, adding bismuth particles 2 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 53° C.

When we applied magnetic field using strong Neodymium magnet to aforementioned heat resistant glass, crests of quantum vortices of Bose-Einstein condensation are observed. The motions of quantum vortices are measured 6 cycles for 10 seconds. The structure of occurring quantum vortices is shown in FIG. 10. Alfven waves occur perpendicular to magnetic force lines. The motions of Alfven waves continue cyclically by quantum soliton motion.

### Experiment 9

Mn—Zn ferrite particles (average size 20 μm) 5 g with, Cu particles (average size 10 μm) 5 g, adding Ti/TiO₂ particles 2 g are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take from microwave oven. The temperature of aforementioned liquid reaches 54° C.

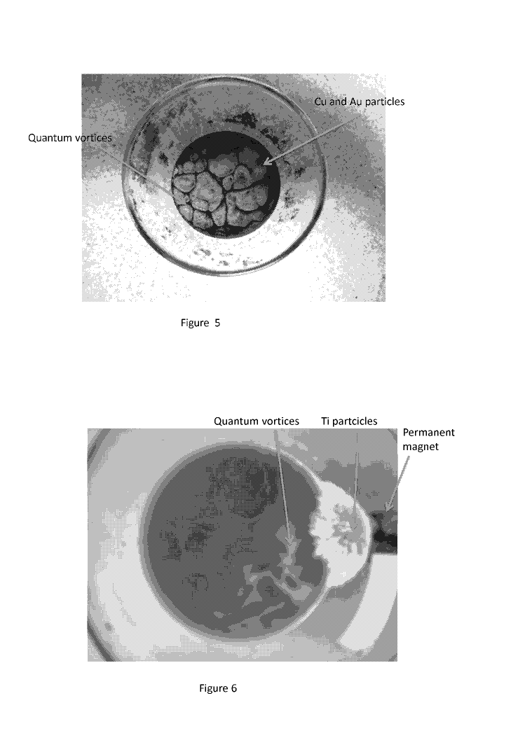

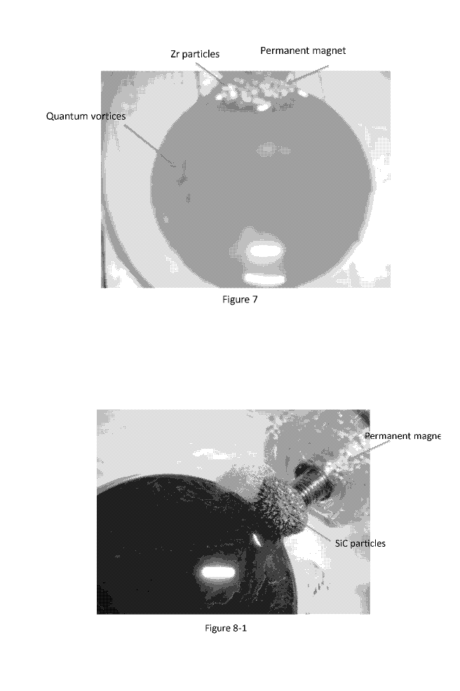

When we applied magnetic field using strong Neodymium magnet to aforementioned heat resistant glass, crests of quantum vortices of Bose-Einstein condensation are observed in FIG. 6 move upward and downward. The motions of quantum vortices are measured 4 cycles for 10 seconds and continue for 9 minutes. The structure of occurring quantum vortices is shown in FIG. 10. Alfven waves occur perpendicular to magnetic force lines. The motions of Alfven waves continue cyclically by quantum soliton motion.

### Experiment 10

Mn—Zn ferrite particles (average size 20 μm) 5 g with, Vanadium particles (average size 10 μm) 5 g, are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 54° C.

When we applied magnetic field using strong Neodymium magnet to aforementioned heat resistant glass, crest of quantum vortices of Bose-Einstein condensation is observed move upward and downward. The motions of quantum vortices are measured 3 cycles for 10 seconds and continue for 9 minutes. The structure of occurring quantum vortices is shown in FIG. 10. Alfven waves occur perpendicular to magnetic force lines. The motions of Alfven waves continue cyclically by quantum soliton motion.

### Experiment 11

Mn—Zn ferrite particles (average size 20 μm) 5 g with, Zirconia particles (average size 10 μm) 5 g, are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 54° C.

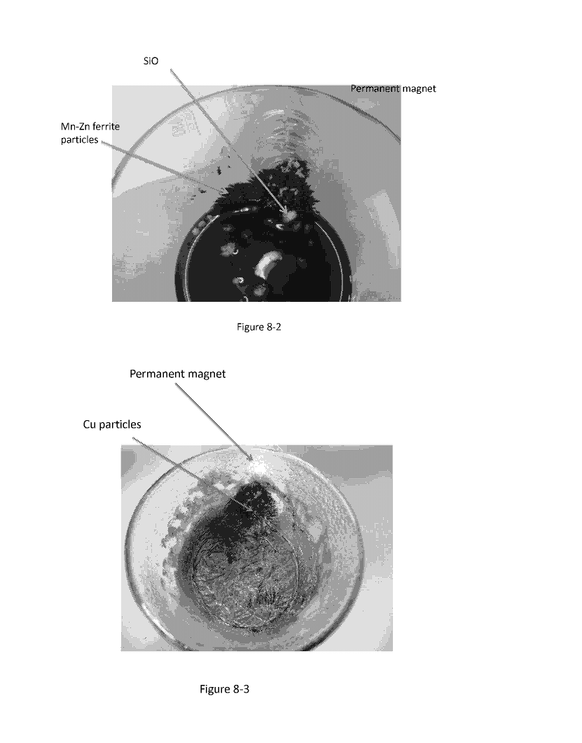

When we applied magnetic field using strong Neodymium magnet to aforementioned heat resistant glass, crest of quantum vortices of Bose-Einstein condensation is observed in FIG. 7 move upward and downward larger than experiment 1. The motions of quantum vortices are measured 3 cycles for 10 seconds and continue for 9 minutes. The structure of occurring quantum vortices is shown in FIG. 10. Alfven waves occur perpendicular to magnetic force lines. The motions of Alfven waves continue cyclically by quantum soliton motion.

### Experiment 12

Mn—Zn ferrite particles (average size 20 μm) 5 g with W, Carbon, activated Carbon and Carbon fiber, are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. The temperature of aforementioned liquid reaches 54° C.

When we applied magnetic field using strong Neodymium magnet to aforementioned heat resistant glass, quantum vortices are not observed in W, crest of quantum vortices of Bose-Einstein condensation is observed in Carbon or Carbon fiber move upward and downward larger than experiment 1. The plasma reaction is observed in Carbon and Carbon fiber in aforementioned magnetic fluid of heat resistance glass. W, Carbon, activated Carbon and Carbon fiber is black color and total absorber of electromagnetic waves. Non-equilibrium electromagnetic field is formed and plasma reaction is formed in Carbon and Carbon fiber by microwaves irradiation and quatum vortices occur. The structure of occurring quantum vortices is shown in FIG. 10. Alfven waves occur perpendicular to magnetic force lines. The motions of Alfven waves continue cyclically by quantum soliton motion.

### Experiment 13

Mn—Zn ferrite particles (average size 20 μm) 5 g with, Silver, Aluminum, Zinc, and Tin particles (average size 10 μm) 5 g, are immersed in organic polyphenol (red wine 50 cc) with adding surface activated material 5 cc in a heat resistant glass (diameter 75 mm, bottom diameter 45 mm, height 55 mm). We irradiate microwaves (2.45 GHz, 500 W) to initial temperature 18° C. aforementioned particles liquid for 30 seconds and take out from microwave oven. When we applied magnetic field using strong Neodymium magnet to aforementioned heat resistant glass, no crest of quantum vortices of Bose-Einstein condensation is observed.

### Experiment 14

Mn—Zn ferrite particles (average size 20 μm) 5 g with, Cu particles (average size 10 μm) 5 g, are immersed red wine, grape juice, cassis alcohol, cassis juice, blue berry alcohol, blue berry juice, Tomato juice, Carrot juice, Apple juice, malic acid or citric acid in organic polyphenol (red wine 50 cc) with adding surface activated material 5 cc in a heat resistant glass (diameter 75 mm, bottom diameter 45 mm, height 55 mm) and diffuse particles. We irradiate microwaves (2.45 GHz, 500 W) to initial temperature 18° C. aforementioned particles liquid for 30 seconds, reaches 53° C. and take out from microwave oven. When we applied magnetic field using strong Neodymium magnet to aforementioned heat resistant glass, crest of quantum vortices of Bose-Einstein condensation is observed.

The multiple phase magnetic fluid which contains red wine, cassis alcohol, or blue berry alcohol shows strong reaction and action of vortices. Next strong reaction is observed in that of grape juice, cassis juice or blue berry juice then malic acid or apple juice is following. Citric acid is weak but shows reaction. Tomato juice or Carrot juice shows no reaction. We attach 50 g iron to Neodymium magnet and make it hang from the bottom of the heat resistance glass and compare the force. 50 g iron and Neodymium magnet are hung from the bottom of multiple phase magnetic fluid which contains red wine, cassis alcohol or blue berry alcohol. 40 g iron and Neodymium magnet drop without succeeding hanged from the bottom of heat resistance glass of multiple phase magnetic fluid which contains apple juice, cassis juice or blue berry juice but 30 g iron and Neodymium magnet are hung. 20 g iron and Neodymium magnet drop without succeeding hanged from the bottom of heat resistance glass of multiple phase magnetic fluid which contains malic acid or citric acid. 10 g iron and Neodymium magnet are hung from the bottom of multiple phase magnetic fluid which contains apple juice or malic acid but are dropped from multiple phase magnetic fluid which contains citric acid.

The multiple phase magnetic fluid which contains tomato juice and carrot juice feel Mn—Zn ferrite only shows sensitive to Neodymium magnet in multiple phase magnetic fluid which contains tomato juice and carrot juice feel. The magnetization of Mn—Zn ferrite is lowered than that in pure water. The magnetization of multiple phase of magnetic fluid increases in that contains a lot of polyphenol such as red wine, cassis liquid or blue berry but decreases in that contains tomato juice or carrot juice.

Surface electrons of copper in multiple phase magnetic fluid which contains polyphenol a lot are transformed to un-paired electrons. The common feature of red wine, cassis alcohol, or blue berry alcohol is that they contain catechin and anthocyanin. When we add surface activated material 3 cc in multiple phase magnetic fluid which contains red wine, 55 g of iron and Neodymium magnet can be hung from the bottom of heat resistance glass of multiple phase magnetic fluid.

Aforementioned all experiments are vertical direction weight comparison. Neodymium magnets are diameter 5 mm, weight 5 g and cylindrical magnet 5 g. We prepare iron is 10 g and 1 cm diameter of 10 pieces. We hang Neodymium magnet and pieces of iron from the bottom of heat resistance glass of multiple phase magnetic fluid and compare the weight of iron pieces.

### Experiment 15

We compare the magnetization changes of Cu particles using different kinds of wines, Spanish red wine, French red wine, Italian red wine or Japanese red wine as in experiment 1 of same heat resistance glass and Mn—Zn ferrite. We use 50 g red wine and 5 g Mn—Zn ferrite particles and Cu particles adding surface activated material then irradiate microwaves using microwave oven for 30 minutes. We compared the magnetization changes as in experiment 14. The initial temperature of liquid is 18° C. and 53° C. after irradiation. According to aforementioned tests, no large deviation of magnetization changes is observed.

We use Spanish red wines in following experiments.

### Experiment 16

We immerse Mn—Zn ferrite particles 5 g and following material elements, oxidized material or their alloy immersed in Spanish red wine in heat resistance glass (diameter 75 mm, bottom diameter 45 mm and height 55 mm) adding surface activated material and we carry out the experiments of magnetization of following material elements, oxidized material and quantum vortices of Bose-Einstein condensation. We use 2.45 GHz and 500 W microwave oven. Initial temperature of aforementioned liquid is 18° C. After irradiation of microwaves, temperature of liquid reaches 53° C.

Paramagnetic particles of Ti, V, Pt, Sn, W, Al, Zr, Nd, Mo and Pd, diamagnetic particles Cu, Zn, Si, Ag, Cd, Se, Sn, Au, Hg, In, Bi, P and compound particles (5˜20 μm) TiO₂, Al₂O₃, V₂O₅, Pb₂O₄, PbO, SiO₂, SiC, HgS, Sb₂O₃, Fe₂O₃, CoO, MnO₄, CrO₇, NiO show ferromagnetism and confirm magnetism transformed. The strength of magnetism is compared the method of experiment 12 in which Neodymium magnet and iron pieces are hung and compare their weight. Ferromagnetic transformation has peculiar electron bonds. The elements Ti, V, Cu, Zn, Nb, Mo, Pd, Ag, Cd, Ta, W, Pt, Au, Au, or Hg particles which have d electron bond show strong ferromagnetic transformation. The elements of particles which have p electron or s electron bond such as C, Al, Si, P, Sn, Pd, Sb, or Bi show weak ferromagnetic transformation. The elements of particles which have S electron bond do not show ferromagnetism transformation.

The elements of particles in which crest of quantum vortices of Bose Einstein condensation is observed are Cu particles, Au particles, Ti particles, Bi, or Pt particles and their compound particles. Evidences of crest of Bose-Einstein condensation are observed in oxidized compound TiO₂, Al₂O₃, Fe₂O₃, CoO, V₂O₅, Pd₂O₄, PdO, MnO₄, CrO₇ or NiO also compounds HgS or Sb₂S₃ and experimental results of experiment 1, experiment 2, experiment 3, experiment 4 and experiment 5. The irradiated light in which quantum vortices of Bose-Einstein condensation are observed is existed in wavelength 450 nm to 780 nm from red color to green color. The copper and gold have 50% absorption and reflection in this wave region. The black color, total light absorber, elements which are Ta, W or C are not observed quantum vortices of Bose-Einstein condensation. White silver color elements which are V, Pt, Sn, Nb, Mo, Ag, Hg or Al have reflective quality of light. We can understand the relation of reflection and absorption of light and crest of quantum vortices of Bose-Einstein condensation. Gold and copper have from 30% to 70% absorption and reflection rate in wavelength from 300 nm to 570 nm. For occurring quantum vortices in microwave region similar absorption and reflection rate of copper and gold is optimal. There are material elements which have absorption and reflection wavelength from 10% to 90% in light wavelength 340 nm to 780 nm occur quantum vortices of Bose-Einstein condensation. When we use microwave 19 GHz, silver color material elements, V, Pt, Sn, Nb, Mo or Hg show quantum vortices of Bose-Einstein condensation using blue color elements and blue berry alcohol liquid. As a result of that, the energy of superfluid is greater in using 19 GHz microwaves than that of 2.45 GHz.

### Experiment 17

We carry out the experiments of Copper particles and CdS/CdSe of the multiple phase magnetic fluid in experiment 1, 2 or 3 depending the ratio of kinds of particles and observe the crest of vortices of Bose-Einstein condensation.

The crest of vortices of Bose-Einstein condensation is not observed in 100% Mn—Zn ferrite particles and red wine. Small crest of vortices of Bose-Einstein condensation and small upward or down ward motion are observed in 20% Cu particles and 80% Mn—Zn ferrite particles. Crest of vortices of Bose-Einstein condensation and large upward or down ward motion are observed in 30% Cu particles and 70% Mn—Zn ferrite particles.

Small crest of vortices of Bose-Einstein condensation and small upward or down ward motion are observed in 80% Cu particles and 20% Mn—Zn ferrite particles. Large crest of vortices of Bose-Einstein condensation and large upward or down ward motion are observed in 50% Cu particles and 50% Mn—Zn ferrite particles.

Larger crest of vortices of Bose-Einstein condensation and large upward or down ward motion are observed in ⅓ Cu particles ⅓ CdS/CdSe semiconductor pigment and ⅓ Mn—Zn ferrite particles than crests of 50% Cu particles and 50% Mn—Zn ferrite particles. Largest crest of vortices of Bose-Einstein condensation is observed by the interference of phases of 3 kinds of particles by different frequencies of magnetoplasmon resonance. The structure of occurring quantum vortices is shown in FIG. 10. Alfven waves occur perpendicular to magnetic force lines. The motions of Alfven waves continue cyclically by quantum soliton motion.

### Experiment 18

We immerse Mn—Zn ferrite (average 20 μm) 5 g, Carbon fiber, activated Carbon and Carbon particles (average 20 μm) 5 g, Cu particles and CdS/CdSe particles (average 20 # m) 5 g adding surface activated material 5 cc in red wine in heat resistance glass and irradiate microwaves (2.45 GHz), 500 W to aforementioned contents of heat resistance glass for 30 seconds. As a result of that plasma reaction of is Carbon fiber, activated Carbon and Carbon particles (average 20 μm) 5 g, is observed.

Quantum vortices of Bose-Einstein condensation is observed by applying strong magnetic field using Neodymium magnet and big fluid tunulence.

The structure of occurring quantum vortices is shown in FIG. 10. Alfven waves occur perpendicular to magnetic force lines. The motions of Alfven waves continue cyclically by quantum soliton motion.

### Experiment 19

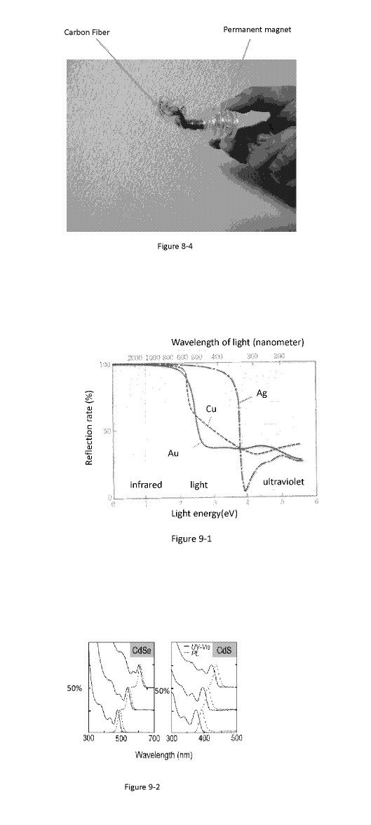

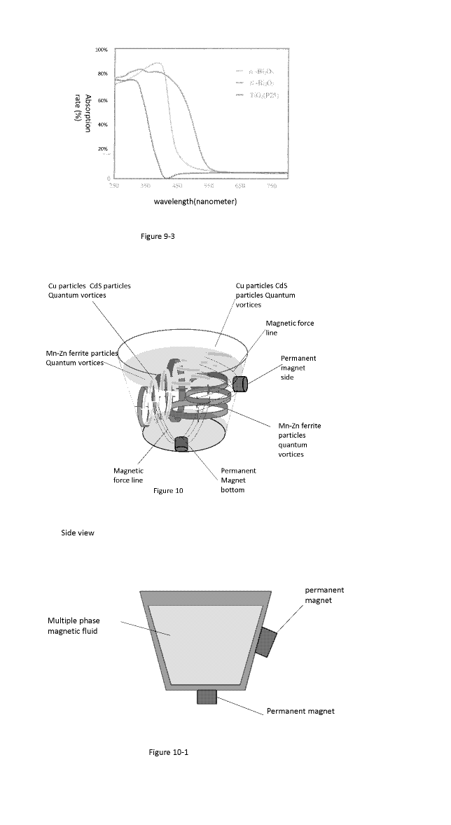

We immerse Mn—Zn ferrite (average 20 μm) 5 g, Carbon fiber, activated Carbon and Carbon particles (average 20 μm) 5 g, adding surface activated material 5 cc in red wine in heat resistance glass and irradiate microwaves (2.45 GHz), 500 W to aforementioned contents of heat resistance glass for 30 seconds. After Carbon fiber, activated Carbon and Carbon particles (average 20 μm) 5 g are separated from Mn—Zn ferrite particles, Carbon fiber, activated Carbon and Carbon particles (average 20 μm) 5 g are attracted permanent magnet. Carbon fiber, activated Carbon and Carbon particles are observed ferromagnetic transformed. The picture is shown in FIG. 8-4.

The spontaneous magnetization values of average size 20 μm Mn—Zn ferrite particles and average size 20 μm Cu particles, Ag particles, Al₂O₃ particles, W₂O₃ particles, TiO₂ particles, Au particles, Zr particles, SiC particles, CdS/CdSe or Carbon fiber mixing each other immersed in red wine with adding surface activated material in heat resistance glass and microwave irradiation, using the probe of magnetometer from outside the glass by contacting probe on glass by fixing measuring point. (using Tesla meter model TM-701 by Kanetec) are following; 0.25 mT (Mn—Zn 5 g), 0.4 mT (Mn—Zn 5 g and Cu 2 g), 0.65 mT (Mn—Zn 5 g and Ag 2 g), 0.3125 mT (Mn—Zn 5 g and Al₂O₃ 2 g), 0.5 mT (Mn—Zn 5 g and W₂O₃2 g), 0.73 mT (Mn—Zn 5 g and TiO₂ 2 g), 0.5428 mT (Mn—Zn 5 g and Carbon fiber 2 g), 0.375 mT (Mn—Zn 5 g, Au 2 g), 0.345 mT (Mn—Zn 5 g and SiC 2 g) and 0.38 mT (Mn—Zn 5 g and SiO₂ 2 g).

We inject Argon gas into multiple phase magnetic fluid in which ferromagnetic particles, ferromagnetic transformed metal particles and semiconductor pigment and microwaves or light continuously to aforementioned multiple phase magnetic fluid for occurring quantum plasma effect, it becomes superfluid condition, quantum chaos occurs and thus energy of superfluid is enhanced by quantum turbulent phenomena.

The multiple phase magnetic fluid which is enhanced by quantum turbulence by quantum chaos leads to rotational movement using rotator. The energy of multiple phase magnetic fluid is transformed into electric generating energy by quantum rotator. We mix ferromagnetic and ferrimagnetism particles mixing metal particles, compound or oxidized metal particles and immerse aforementioned mixed particles in red wine, cassis alcohol, grape juice and blueberry juice which include polyphenol, malic acid and citric acid with adding surface activated materials to diffuse that liquid and increase photo-enhancement sensibility. When we irradiate microwaves to aforementioned fluid liquid, paramagnetic particles, component or oxidized particles of Titan, Vanadium, Platinum, Stannum, Tungsten, Aluminum, Zyrconia, Neodymium, Molybdenum and Paradium and copper, Zinc, Silicon, Silver, Cadmium, Selenium, Stannum, Platinum, Stibium, Hydragyrum, Indium, Bismuth or Phosphorous, Oxidized compound of Mn, Ni, Cr, Fe, Co such as MnO₄, CrO₇, Fe₂O₃, CoO, NiO show magnetization and make multiple phase magnetic fluid.

We irradiate microwaves and apply strong magnetic field using permanent magnet to aforementioned multiple phase magnetic fluid, the superfluid energy is created.

The superfluid energy is enhanced by quantum turbulence occurring quantum chaos using semiconductor pigment in which photosensitivity is created by exciton.

The examples of semiconductor pigment is (B,Al,Ga,In)(N,P,As,Sb) elements III-V group semiconductor pigment, (Mg,Zn, Cd,Hg)(O,S,Se,Te) elements II-IV group semiconductor pigment and (Sn,Pb)(S,Se,Te)elements IV-VI group semiconductor pigment.

The material elements which are needed for microwave superfluid are common and cheap. The energy theme of 21 century is to restrict negative environmental fact and scarce natural resource and develop self-sustainable energy.

Superfluid energy is main of magnetic fluid generator which is mobile, environmental free and free CO₂ generator and avoid environmental problem such as global warming.

The decreasing materials are evaporation of red wine, Argon gas and decay of magnetization. Tolerance years of use are very long. This is cost merit generator.

1. An amplification method of superfluid energy of multiple phase magnetic fluid by quantum turbulence occurring quantum chaos and quantum soliton of Alfven waves under quantum effect of coherent Bose-Einstein condensation of electromagnetic waves or light interaction with multiple phase magnetic fluid comprising steps of:
inducion magnetoplasmon effect, using paramagnetic particles, component or oxidized particles of Titan, Vanadium, Platinum, Stannum, Tungsten, Aluminum, Zyrconia, Neodymium, Molybdenum and Paradium and Copper, Zinc, Silicon, Silver, Cadmium, Selenium, Stannum, Platinum, Stibium, Hydragyrum, Indium, Bismuth or Phosphorous, using oxidized particles of Manganese, Nickel, Crome, Iron or Cobalt, mix aforementioned particles in ferromagnetic and ferrimagnetism particles and immerse aforementioned mixed particles in red wine, cassis alcohol, grape juice and blueberry juice which include polyphenol, malic acid and citric acid with adding surface activated materials to diffuse that multiple phase magnetic fluid and increase photo-enhancement sensitivity and irradiating microwaves to aforementioned multiple phase magnetic fluid, paramagnetic particles, component or oxidized particles of Titan, Vanadium, Platinum, Stannum, Tungsten, Aluminum, Zyrconia, Neodymium, Molybdenum or Paradium and copper, Zinc, Silicon, Silver, Cadmium, Selenium, Stannum, Platinum, Stibium, Hydragyrum, Indium, Bismuth or Phosphorous, Oxidized compound of Mn, Ni, Cr, Fe, Co such as MnO₄, CrO₇, Fe₂O₃, CoO, NiO show magnetization, by excitation of unpaired electron of void of metal crystal lattice by magnetic resonance and inorganic materials Silicon, Silicon Carbide, Carbon fiber or activated carbon show spontaneous magnetization which causes spin-cyclotron resonance and plasmon resonance of surface electron on said particles or spin-cyclotron resonance and plasma reaction of surface electron of Carbon fiber or activated carbon by in-equilibrium electromagnetic field,
occurrence of superfluid phenomena of quantum vortices in said multiple phase magnetic fluid using microwaves under room temperature and room pressure, amplifying electromagnetic field energy by exciton of semiconductor compound or pigment, formed by recombination of electron and hole of semiconductor pigment or compound and charged materials wherein Alfven waves are induced by photosensitivity of magnetoplasmon oscillation and quantum turbulence is induced in occurring quantum chaos in superfluid phenomena in multiple phase of magnetic fluid containing ferromagnetic particles, ferromagnetism transformed metal particles and semiconductor pigment III-V semiconductor compound (B,Al,Ga,In)(N,P,As,Sb), II-IV semiconductor compound (Mg,Zn,Cd,Hg)(O,S,Se,Te) and IV-VI semiconductor compound (Sn,Pb)(S,Se,Te) adding said superfluid condition of multiple phase magnetic fluid.

2. An amplification method of superfluid energy of said multiple phase magnetic fluid recited claim 1 by quantum turbulence occurring quantum chaos and quantum soliton of Alfven waves under quantum effect of plasma by adding rare gases, applying magnetic field and irradiating microwaves wherein subcritical condition reaches by plasma effect of rare gases and magnetoplasmon effect of superfluid of said multiple phase magnetic fluid recited claim 1.

3. An amplification method of superfluid by quantum turbulence occurring quantum chaos of said multiple phase magnetic fluid recited claim 1 applying gradient of magnetic field and gradient rout space of rout of said multiple phase magnetic fluid wherein cyclic changes occur in electro-conductivity, viscosity, heat conduction, density and diffusing velocity.
